(19) United States
(12) Patent Application Publication
(10) Pub. No.: US 2019/0336918 A1
(43) Pub. Date: Nov. 7, 2019

(54) POROUS ALUMINA-CARBON BASED COMPOSITE MEMBRANE AND ITS FABRICATION METHOD

(71) Applicant: KING FAHD UNIVERSITY OF PETROLEUM AND MINERALS, Dhahran (SA)

(72) Inventors: Tahar LAOUI, Dhahran (SA); Hafiz Khurram Shahzad, Dhahran (SA); Mohamed Abdrabou Hussein, Dhahran (SA)

(73) Assignee: KING FAHD UNIVERSITY OF PETROLEUM AND MINERALS, Dhahran (SA)

(21) Appl. No.: 15/971,862

(22) Filed: May 4, 2018

(51) Int. Cl. B01D 71/02; B01D 67/00; C02F 1/44; C04B 35/80; C04B 35/64

(52) U.S. Cl. CPC B01D 71/021; B01D 71/025; B01D 67/0041; C02F 2101/20; C04B 35/803; C04B 35/64; C02F 1/44

(57) ABSTRACT

Durable, porous alumina-carbon nanotube membranes and methods for making them using spark plasma sintering. Methods for removing heavy metals such as cadmium from waste water using alumina-carbon nanotube membranes.

### STATEMENT OF FUNDING ACKNOWLEDGEMENT

Funding for this research through the National Science Technology and Innovation Plan of the Kingdom of Saudi Arabia is gratefully acknowledged under grant NSTIP 13-ADV2184-04.

### STATEMENT REGARDING PRIOR DISCLOSURES BY THE INVENTOR(S)

Aspects of this technology are described by a Thesis Defense (oral presentation) on May 4, 2017 and by H. K. Shahzad, et al., Porous Alumina-Carbon Nanotubes Nanocomposite Membranes Processed via Spark Plasma Sintering for Heavy Metal Removal from Contaminated Water; ICIM 2017: 19^{th} International Conference on Inorganic Membranes, Barcelona, Spain, May 26-27, 2017.

### BACKGROUND

Field of the Invention

The present disclosure relates to durable alumina-carbon nanotube membranes and methods for making them by sintering processes including by spark plasma sintering or by uniaxial pressing and consolidation through pressure-less, solid-state sintering. Methods for removing heavy metals such as cadmium from waste water using alumina-carbon nanotube membranes are also disclosed.

Description of Related Art

The “background” description provided herein is for the purpose of generally presenting the context of the disclosure. Work of the presently named inventor(s), to the extent it is described in this background section, as well as aspects of the description which may not otherwise qualify as prior art at the time of filing, are neither expressly or impliedly admitted as prior art against the present invention.

Influence of Spark Plasma Sintering Parameters on the Properties of Alumina-CNT Nanocomposite Membranes.

Water treatment processes aim to remove undesirable constituents from water. Among water treatment processes, membrane filtration is both promising and widely used. See Qu, X., Alvarez, P. J., and Li, Q., 2013. Applications of nanotechnology in water and wastewater treatment. Water research, 47(12), pp. 3931-3946; and S. Kar, R. C. Bindal, P. K. Tewari, Carbon nanotube membranes for desalination and water purification: challenges and opportunities, Nano Today 7 (2012) 385-389, each incorporated herein by reference in their entirety. Such membranes must have high efficiency, high stability, and low energy requirements, and must provide a physical barrier for the constituents of interest based on their size. While it is possible to use both organic and inorganic materials for membranes, ceramic membranes are more attractive than membranes made from organic polymers because ceramic materials have a higher fouling resistance and are more chemically stable. See M. M. Pendergast, E. M. V. Hoek, A review of water treatment membrane nanotechnologies, Energy. Environ. Sci. 4 (2011) 1946-1971, incorporated herein by reference in its entirety.

Hydrophilic metal oxide nanoparticles, such as Al₂O₃, SiO₂, zeolite, and TiO₂, are attractive membrane materials because of their high water permeability. See N. Maximous, G. Nakhla, K. Wong, W. Wan, Optimization of Al₂O₃/PES membranes for wastewater filtration, Separation and Purification Technology, 73 (2) (2010), pp. 294-301; A. Bottino, G. Capannelli, V. D'Asti, P. Piaggio, Preparation and properties of novel organic-inorganic porous membranes, Separation and Purification Technology, 22-23 (1-3) (2001), pp. 269-275; M. T. M. Pendergast, J. M. Nygaard, A. K. Ghosh, E. M. V. Hoek, using nanocomposite materials technology to understand and control reverse osmosis membrane compaction, Desalination, 261 (3) (2010), pp. 255-263; and T. Bae, Tak, Effect of TiO2 nanoparticles on fouling mitigation of ultrafiltration membranes for activated sludge filtration, Journal of Membrane Science, 249 (1-2) (2005), pp. 1-8, each incorporated herein by reference in their entirety. Alumina was reported to be a good absorbent. See Agarwal, Madhu, and K. Singh. Heavy metal removal from wastewater using various adsorbents: a review. Journal of Water Reuse and Desalination 7, no. 4 (2017): 387-419, incorporated herein by reference in its entirety. In addition, incorporating nanomaterials into the membrane can improve the membrane permeability, thermal stability, fouling resistance, and mechanical properties, as well as provide new functions for self-cleaning and contaminant degradation. See Qu et al. One example of such a nanomaterial additive is carbon nanotubes (CNTs), which have been found to be useful for heavy metal ion removal and water purification applications due to their unique properties, including their ability to improve membrane permeability, rejection, disinfection and antifouling behavior. See Ihsanullah, F. A. A. Khaldi, B. Abusharkh, M. Khaled, M. A. Atieh, M. S. Nasser, T. Laoui, S. Agarwal, I. Tyagi, V. K. Gupta, Adsorptive removal of Cadmium (II) ions from liquid phase using acid modified carbon-based adsorbents, J. Mol. Liq. 204 (2015) 255-263; Ihsanullah, Al-Khaldi, F. A., Abu-Sharkh, B., Abulkibash, A. M., Qureshi, M. I., Laoui, T. and Atieh, M. A., 2015. Effect of acid modification on adsorption of hexavalent chromium (Cr (VI)) from aqueous solution by activated carbon and carbon nanotubes. Desalination and Water Treatment, pp. 1-13; C. Chen, J. Hu, D. Shao, J. Li, X. Wang, Adsorption behavior of multiwall carbon nanotube/iron oxide magnetic composites for Ni(II) and Sr(II), J. Hazard. Mater. 164 (2009) 923-928; Z. C. Di, Y. H. Li, Z. K. Laun, J. Liang, Adsorption of chromium(VI) ions from water by carbon nanotubes, Adsorpt. Sci. Technol. 22 (2004) 467-474; S. G. Wang, W. X. Gong, X. W. Liu, Y. W. Yao, B. Y. Gao, Q. Y. Yue, Removal of lead(II) from aqueous solution by adsorption onto manganese oxide-coated carbon nanotubes, Sep. Purif Technol. 58 (2007) 17-23; C. Chen, X. Wang, Adsorption of Ni (II) from aqueous solution using oxidized multiwall carbon nanotubes, Ind. Eng. Chem. Res. 45 (2006) 9144-9149; C. L. Chen, X. K. Wang, M. Nagatsu, Europium adsorption on multiwall carbon nanotube/iron oxide magnetic composite in the presence of polyacrylic acid, Environ. Sci. Technol. 43 (2009) 2362-2367; B. S. Lalia, F. E. Ahmed, T. Shah, N. Hilal, R. Hashaikeh, Electrically conductive membranes based on carbon nanostructures for self-cleaning of biofouling, Desalination 360 (2015) 8-12; J. K. Holt, A. Noy, T. Huser, D. Eaglesham, O. Bakajin, Fabrication of a carbon nanotube-embedded silicon nitride membrane for studies of nanometer-scale mass transport, Nano Lett. 4 (2004) 2245-2250; S. Li, G. Liao, Z. Liu, Y. Pan, Q. Wu, Y. Weng, X. Zhang, Z. Yang, O. K. C. Tsuid, Enhanced water flux in vertically aligned carbon nanotube arrays and polyethersulfone composite membranes, J. Mater. Chem. A. 2 (2014) 12171-12176; M. Majumder, N. Chopra, R. Andrews, B. J. Hinds, Nanoscale hydrodynamics: enhanced flow in carbon nanotubes, Nature 438 (2005) 44; J. K. Holt, H. G. Park, Y. Wang, M. Stadermann, A. B. Artyukhin, C. P. Grigoropoulos, A. Noy, O. Bakajin, Fast mass transport through Sub-2-nanometer carbon nanotubes, Science 312 (2006) 1034-1037; P. S. Goh, A. F. Ismail, B. C. Ng, Carbon nanotubes for desalination: performance evaluation and current hurdles, Desalination 308 (2013) 2-14; B. J. Hinds, N. Chopra, R. Andrews, V. Gavalas, L. G. Bachas, Aligned multiwalled carbon nanotube membranes, Science 303 (2004) 62-65; S. A. Miller, V. Y. Young, C. R. Martin, Electroosmotic flow in template-prepared carbon nanotube membranes, J. Am. Chem. Soc. 123 (2001) 12335-12342; W. Chengwei, L. Menke, P. Shanlin, L. Hulin, Well-aligned carbon nanotube array membrane synthesized in porous alumina template by chemical vapor deposition, Chin. Sci. Bull. 45 (2000) 1373-1376; A. Srivastava, O. N. Srivastava, S. Talapatra, R. Vajtai, P. M. Ajayan, Carbon nanotube filters, Nat. Mater. 3 (2004) 610-614; L. F. Dumee, K. Sears, J. Schutz, N. Finn, C. Huynh, S. Hawkins, M. Duke, S. Gray, Characterization and evaluation of carbon nanotube Bucky-Paper membranes for direct contact membrane distillation, J. Membr. Sci. 351 (2010) 36-43; R. Andrews, D. Jacques, A. M. Rao, F. Derbyshire, D. Qian, X. Fan, E. C. Dickey, J. Chen, Continuous production of aligned carbon nanotubes: a step closer to commercial realization, Chem. Phys. Lett. 303 (1999) 467-474; S. Majeed, D. Fierro, K. Buhr, J. Wind, B. Du, A. B. D. Fierro, V. Abetz, Multi-walled carbon nanotubes (MWCNTs) mixed polyacrylonitrile (PAN) ultrafiltration membranes, J. Membr. Sci. 403-404 (2012) 101-109; D. L. Arockiasamy, J. Alam, M. Alhoshan, Carbon nanotubes-blended poly (phenylene sulfone) membranes for ultrafiltration applications, Appl. Water Sci. 3 (2013) 93-103; J. H. Choi, J. Jegal, W. N. Kim, Fabrication, and characterization of multi-walled carbon nanotubes/polymer blend membranes, J. Membr. Sci. 284 (2006) 406-415; Ihsanullah, T. Laoui, A. M. Al-Amer, A. B. Khalil, A. Abbas, M. Khraisheh, M. A. Atieh, Novel anti-microbial membrane for desalination pretreatment: a silver nanoparticle-doped carbon nanotube membrane, Desalination 376 (2015) 82-93, each incorporated herein by reference in their entirety. The addition of CNT to Alumina will provide strength to the membranes and also work as absorbent for heavy metal removal. In this study, MWCNT is selected as it was found to show higher water permeability compared to SWCNT. See Das, Rasel, Md Eaqub Ali, Sharifah Bee Abd Hamid, Seeram Ramakrishna, and Zaira Zaman Chowdhury. Carbon nanotube membranes for water purification: a bright future in water desalination. Desalination 336 (2014): 97-109, incorporated herein by reference in its entirety. Although the biocompatibility of CNTs remains questionable, it can potentially be improved with the use of CNT-based composites. See N Smart, S. K., et al., The biocompatibility of carbon nanotubes. Carbon 44.6 (2006): 1034-1047; and Wang, Wei, et al., Carbon nanotubes reinforced composites for biomedical applications. BioMed research international 2014 (2014), each incorporated herein by reference in their entirety. In composite materials, the processing route used to fabricate the composites can be especially important for the final material's performance.

Various processing routes have been reported in the literature for the fabrication of ceramic-based nanocomposite membranes, including conventional sintering techniques, and vibration and pressing compaction. See Barma, Sanjib, and Bishnupada Mandal. Effects of sintering temperature and initial compaction load on alpha-alumina membrane support quality. Ceramics International 40.7 (2014): 11299-11309; Patel, F., Mirza A. Baig, and Tahar Laoui. Processing of porous alumina substrate for the multilayered ceramic filter. Desalination and Water Treatment 35.1-3 (2011): 33-38; and Ghaderi, Mohammad Javad, Mandi Shafiee Afarani, and Ghodratollah Roudini. Synthesis of alumina porous supports via different compaction routes: vibration and pressing. Journal of Chemical Technology and Metallurgy 48.3 (2013): 289-295, each incorporated herein by reference in their entirety. Vibration and pressing compaction methods were reported for the fabrication of porous alumina and alumina-silica supports. See Ghaderi et al. Porous alumina supports were fabricated by conventional sintering. See Qin, W., Peng, C., Lv, M. and Wu, J., 2014. Preparation and properties of high purity porous alumina support at the low sintering temperature. Ceramics International, 40(8), pp. 13741-13746, incorporated herein by reference in its entirety. Porous alumina that was structurally modified with carbon nanotubes (CNTs) has been synthesized by gel casting followed by high-temperature reductive sintering. See Hai, Chunxi, Takashi Shirai, and Masayoshi Fuji. Fabrication of conductive porous alumina (CPA) structurally modified with carbon nanotubes (CNT). Advanced Powder Technology 24.5 (2013): 824-828, incorporated herein by reference in its entirety. Porous alumina-CNT composites have also been prepared by in situ growth of CNTs within the porous alumina matrix via thermal pyrolysis. See Parham, Hamed, Andrew Kennedy, and Yanqiu Zhu. Preparation of porous alumina-carbon nanotube composites via direct growth of carbon nanotubes. Composites Science and Technology 71.15 (2011): 1739-1745, incorporated herein by reference in its entirety.

SPS is preferred over conventional sintering techniques due to the simultaneous effects of pressure and temperature, which facilitate the formation of fine pores by enabling increased heating rates, reduced sintering times, and reduced temperatures, compared with those of conventional sintering. Moreover, SPS yields stronger materials at lower processing temperatures compared with hot pressing and conventional sintering. See Ostrowski, T. and Rödel, J., Evolution of mechanical properties of porous alumina during free sintering and hot pressing. J. Am. Ceram. Soc., 1999, 82, 3080-3086; and Deng, Z. Y., Fukasawa, T., Ando, M., Zhang, G. J. and Ohji, T., Microstructure and mechanical properties of porous alumina ceramics by the decomposition of aluminum hydroxide. J. Am. Ceram. Soc., 2001, 84, 2638-2644, each incorporated herein by reference in their entirety. In addition, the membrane porosity can be controlled by the SPS temperature. See Jayaseelan, D. Doni, et al. High-Strength Porous Alumina Ceramics by the Pulse Electric Current Sintering Technique. Journal of the American Ceramic Society 85.1 (2002): 267-269, each incorporated herein by reference in its entirety. Therefore, SPS techniques have been reported to be promising for synthesizing porous ceramics. See S. T. Oh, K. Tajima, M. Ando, and T. Ohji, Strengthening of Porous Alumina by Pulse Electric Current Sintering and Nanocomposite Processing, J. Am. Ceram. Soc., 83 [5] 1314-16 (2000), incorporated herein by reference in its entirety. Moreover, improvements in the performance and reliability of such porous structures via controlling pore geometry have been reported. See D. J. Green, C. Nader, and R. Brezny, The Elastic Behavior of Partially-Sintered Alumin; pp. 345-56 in Ceramic Transactions, Vol. 7, Sintering of Advanced Ceramics. Edited by C. A. Handwerker, J. E. Blendell, and W. A. Kaysser. American Ceramic Society, Westerville, Ohio, 1990; D. C. C. Lam, F. F. Lange, and A. G. Evans, Mechanical Properties of Partially Dense Alumina Produced from Powder Compacts, J. Am. Ceram. Soc., 77 [8] 2113-17 (1994); S. C. Nanjangud, R. Brezny, and D. J. Green, Strength and Young's Modulus The behavior of a Partially Sintered Porous Alumina, J. Am. Ceram. Soc., 78 [11] 266-68 (1995); C. Kawai and A. Yamakawa, Effect of Porosity and Microstructure on the Strength of Si₃N₄: Designed Microstructure for High Strength, High Thermal Shock Resistance, and Facile Machining, J. Am. Ceram. Soc., 80 [10] 2705-708 (1997); G. Li, Z. Jiang, and L. Zhang, Strengthening of Porous Al₂O₃ Ceramics through Nanoparticle Addition, Nanostruct. Mater., 80 [6] 749-54 (1997), each incorporated herein by reference in their entirety. SPS has been reported to fabricate ceramic-based nanocomposite membranes. Despite these advantages, SPS has not, to the best of our knowledge, been used for the synthesis of alumina-CNT nanocomposite membranes. See Jayaseelan, D. Doni et al.; S. T. Oh et al.; and Chakravarty, Dibyendu, Hayagreev Ramesh, and Tata N. Rao. High strength porous alumina by spark plasma sintering. Journal of the European Ceramic Society 29.8 (2009): 1361-1369, each incorporated herein by reference in their entirety.

As disclosed herein, SPS is used to synthesize porous alumina-CNT nanocomposite membranes and describe the influence of SPS processing parameters on the membrane properties, namely porosity, permeability, and mechanical strength. A nanocomposite powder consisting of alumina with 5 wt % CNTs, was prepared and consolidated into a porous membrane by SPS. The membrane properties were characterized and correlated with the SPS processing parameters to obtain the optimal combination of membrane strength and permeability.

Synthesis and Characterization of Alumina-CNT Membrane for Cadmium Removal from Water.

Over the past few decades, inorganic ceramic membranes have gained increasing attention in water treatment and other applications, e.g., in the food, pigment, chemical, environmental, and pharmaceutical industries, owing to their superior characteristics, such as chemical inertness, thermal stability, corrosion resistance, and high separation efficiency. See H. Qi, Y. Fan et al, Effect of TiO₂ doping on the characteristics of macroporous Al₂O₃/TiO₂ membrane support, J. Eur. Ceram. Soc. 30(6) (2010) 1317-1325; R. W. Baker, Future directions of membrane gas separation technology, Ind. Eng. Chem. Res. 41(6) (2002) 1393-1411; D. Vasanth et al., Fabrication and properties of low-cost ceramic microfiltration membranes for separation of oil and bacteria from its solution, J. Membr. Sci. 379 (2011) 154-163; Y. H. Wang et al, Preparation and sintering of macroporous ceramic membrane support from Titania sol-coated alumina powder, J. Am. Ceram. Soc, 91(3) (2008) 825-830; and R. M. DeVos, H. Verweij, High-selectivity, high-flux silica membranes for gas separation, Science 279(5357) (1998) 1710-1711, each incorporated herein by reference in their entirety.

Conventional ceramic processing methods (e.g., dry-, paste-, or colloidal pressing) followed by sintering have commonly been used to fabricate porous ceramic supports with adequate mechanical strength for ceramic membranes. See P. Maarten Biesheuvel, H. Verweij, Design of ceramic membrane supports permeability, tensile strength, and stress, J. Membr. Sci. 156 (1) (1999) 141-152, incorporated herein by reference in its entirety. The raw materials, processing methods, and sintering techniques adopted in the synthesis have a significant influence on the performance of the final membrane. See M. Fukushima et al, Microstructural characterization of porous silicon carbide membrane support with and without alumina additive, J. Am. Ceram. Soc. 89(5) (2006) 1523-1529, incorporated herein by reference in its entirety. Moreover, the initial powder size, binder type and amount, initial compaction pressure, and sintering temperature can also affect the final pore size, porosity, and permeability of the membranes. See Korosh Shafieia et al; An investigation on the manufacturing of alumina microfiltration membranes. Desalination and water treatment. doi: 10.1080/19443994.2013.867539; and T. Mohammadi et al., Experimental design in mullite microfilter preparation, Desalination 184 (2005) 57-64, each incorporated herein by reference in their entirety. Porous ceramic bodies are commonly synthesized by compacting a green powder into a desired shape, followed by sintering. The properties of a consolidated porous ceramic body (e.g., pore size, porosity, and strength) depend on the processing parameters, such as sintering temperature, time, and heating rate. See A. S. A. Chinelatto, R. Tomasi, Influence of processing atmosphere on the microstructural evolution of submicron alumina powder during sintering, Ceram. Int. 35 (2009) 2915-2920, incorporated herein by reference in its entirety. Barma and Mandal have investigated the effects of the initial compaction load and sintering temperature on the porosity, mechanical strength, and pore size of the resulting membrane. Reducing the sintering temperature or the initial compaction load leads to a higher final porosity and results in a membrane with larger pores. Moreover, the strength of the membrane can be improved by increasing the compaction load or sintering temperature, because of the enhanced grain growth attributed to the greater densification at higher compaction loads or sintering temperatures. See Sanjib Barma, Bishnupada Mandal. Effects of sintering temperature and initial compaction load on alpha-alumina membrane support quality. Ceramics International, 40 (2014) 11299-11309; J. S. Magdeski, The Porosity dependence of mechanical properties of sintered alumina, Journal of the University of Chemical Technology and Metallurgy, 45, 2, 2010, 143-148; each incorporated herein by reference in its entirety.

Hashimoto et al. synthesized a porous alumina body using alumina platelets and varying the compaction pressure at constant sintering temperature (1400° C.); they measured densification of 25 and 35.5% at 1 and 3 MPa, respectively. See S. Hashimoto et al, Synthesis and mechanical properties of porous alumina from anisotropic alumina particles; Journal of the European Ceramic Society Volume 30, Issue 3, February 2010, Pages 635-639, incorporated herein by reference in its entirety. The mechanical properties of porous alumina structures are correlated with their total porosity and relative density. Patel et al. studied the effect of the compaction pressure (230-620 MPa, followed by sintering at 1400° C.) on the final density of porous alumina substrates consisting of alumina; they observed an increase in mechanical strength with increasing initial compaction pressure. See Faheemuddin Patel, Mirza Aqeel Baig, Tahar Laoui, Processing of porous alumina substrate for multilayered ceramic filter, Desalination and Water Treatment 35, issue 1-3, pp. 33-38 (2011), incorporated herein by reference in its entirety.

Porous ceramic membranes have been manufactured from a variety of materials, such as clays, zirconia, titania, silica, and fly ash. See B. K. Nandi et al, Preparation, and characterization of low-cost ceramic membranes for microfiltration applications; Applied Clay Science 42 (2008) 102-110; Falamaki, C., Shafiee, A. M., Aghaie, A., 2004. Initial sintering stage pore growth mechanism applied to the manufacture of ceramic membrane supports. J. Eur. Ceram. Soc. 24, 2285-2292; Yoshino, Y., Suzuki, T., Nair, B. N., Taguchi, H., Itoh, N., 2005. Development of tubular substrates, silica based membranes and membrane modules for hydrogen separation at high temperature. J. Membr. Sci. 267, 8-17; Wang, Y. H., Tian, T. F., Liu, X. Q., Meng, G. Y., 2006. Titania membrane preparation with chemical stability for very harsh environments applications. J. Membr. Sci. 280, 261-269; and Saffaj et al., 2004. Preparation and characterization of ultrafiltration membranes for toxic removal from wastewater. Desalination 168, 259-263; S. Cava et al, Structural characterization of phase transition of Al₂O₃nano powders obtained by polymeric precursor method; Materials Chemistry and Physics 103 (2007) 394-399; each incorporated herein by reference in its entirety.

Alumina is one of the most common materials used to fabricate porous membrane supports for asymmetric membranes, as well as ceramic membrane filters. See Sanjib Barma et al.; Wu Qin et al, Preparation and properties of high purity porous alumina support at low sintering temperature; Ceramics International 40 (2014) 13741-13746; Korosh Shafieia et al; Kyung-Hee Kim et al, Centrifugal casting of alumina tube for membrane application; Journal of Membrane Science 199 (2002) 69-74; and G. C. Steenkamp et al, Centrifugal casting of ceramic membrane tubes and the coating with chitosan; Separation and Purification Technology 25 (2001) 407-413, each incorporated herein by reference in their entirety.

Alumina has also been utilized for the removal of various heavy metals because of its excellent adsorption properties for metal ions. See M. L. Cervera, M. C. Arnal, M. D. L. Gurdia, Removal of heavy metals by using adsorption on alumina or chitosan; Anal. Bioanal. Chem., 375 (2003), pp. 820-825; L. Zhang, T. Huang, M. Zhang, X. Guo, Z. Yuan. Studies on the capability and behavior of adsorption of thallium on nano-Al₂O₃. J. Hazard. Mater. 157 (2008), pp. 352-357; Revathi M et al, Removal of nickel ions from industrial plating effluents using activated alumina as adsorbent, Journal of Environmental Science & Engineering [2005, 47(1):1-6]; Narsi Ram Bishnoi et al, Adsorption of Cr(VI) on activated rice husk carbon and activated alumina, Bioresource Technology Volume 91, Issue 3, February 2004, Pages 305-307; Tadashi Hano et al, Removal of phosphorus from wastewater by activated alumina adsorbent, Water science and technology, 1997, 35 (7) 39-46, each incorporated herein by reference in their entirety. Yabe and Oliveira investigated the adsorption of metal ions from industrial effluents on alumina and found that alumina exhibited excellent adsorption efficiency in the removal of Fe, Cr, Pb, Ni, Cd, Cu, and Zn. See Yabe, Oliveira, Heavy metals removal in industrial effluents by sequential adsorbent treatment; Advances in Environmental Research Volume 7, Issue 2, January 2003, Pages 263-272, each incorporated herein by reference in their entirety.

Carbon nanotubes (CNTs) are relatively new adsorbents with great potential for heavy metal removal. See H. J. Wang, A. L. Zhou, F. Peng, H. Yu, J. Yang, Mechanism study on adsorption of acidified multiwalled carbon nanotubes to Pb(II) J. Colloid Interface Sci., 316 (2007), pp. 277-283; N. A. Kabbashi, M. A. Atieh, A. Al-Mamun, M. E. S. Mirghami, M. D. Z. Alam, N. Yahya, Kinetic adsorption of application of carbon nanotubes for Pb(II) removal from aqueous solution, J. Environ. Sci., 21 (2009), pp. 539-544; and K. Pillay, E. M. Cukrowska, N. J. Coville, Multi-walled carbon nanotubes as adsorbents for the removal of parts per billion levels of hexavalent chromium from aqueous solution, J. Hazard. Mater., 166 (2009), pp. 1067-1075, each incorporated herein by reference in their entirety. The promising potential of CNTs for environmental applications derives from their unique properties, such as large specific surface area, high porosity, low density, high mechanical strength, high thermal and chemical stability, and strong interaction with pollutant species. See Xuemei Ren et al, Carbon nanotubes as adsorbents in environmental pollution management: A Review Chemical Engineering Journal Volume 170, Issues 2-3, 1 Jun. 2011, Pages 395-410; Upadhyayula et al, Application of carbon nanotube technology for removal of contaminants in drinking water: A review. Science of Total Environment Volume 408, Issue 1, 15 Dec. 2009, Pages 1-13; Rao et al, Sorption of divalent metal ions from aqueous solution by carbon nanotubes: A review, Separation and Purification Technology Volume 58, Issue 1, 1 Dec. 2007, Pages 224-231; Mubarak et al, Removal of Heavy Metals from Wastewater Using Carbon Nanotubes; Separation & Purification Reviews Volume 43, 2014, each incorporated herein by reference in their entirety.

Combining alumina and CNT adsorbents thus appears as an attractive strategy to produce a porous nanocomposite membrane with superior adsorption efficiency. Although the electrical, mechanical, thermal, and tribological properties of alumina-CNT composites have been described in several studies, most previous work concerned solid, dense composites, whereas only a few investigations focused on porous alumina-CNT membranes. See Fawad Inam et al; Effects of dispersion surfactants on the properties of ceramic-carbon nanotube (CNT) nanocomposites. Volume 40, Issue 1, Part A, January 2014, Pages 511-516; Seung I. Cha et al, Strengthening and toughening of carbon nanotube reinforced alumina nanocomposite fabricated by molecular level mixing process; Scripta Materialia Volume 53, Issue 7, October 2005, Pages 793-797; L. Kumari et al, Thermal properties of CNT-Alumina nanocomposites; Composites Science and Technology Volume 68, Issue 9, July 2008, Pages 2178-2183; and J.-W. An et al, Tribological properties of hot-pressed alumina—CNT composites; Wear Volume 255, Issues 1-6, August-September 2003, Pages 677-681, each incorporated herein by reference in their entirety.

Moreover, powder metallurgical technique was used to synthesize the substrate only instead of the membrane itself. Chemical vapor deposition (CVD) is commonly used to grow CNTs on ceramic templates to develop CNT-based composite membranes. Altalhi et al. fabricated carbon nanotube composite membranes by growing multiwalled CNTs (MWCNTs) on an alumina-polyamide template by CVD. See Tariq Altalhi et al, Synthesis of Carbon Nanotube (CNT) Composite Membranes; Membranes 2011, 1, 37-47; doi: 10.3390/membranes1010037, incorporated herein by reference in its entirety. Parham et al. reported a thermal pyrolysis technique for the in-situ growth of carbon nanotube-containing porous alumina structures. Carbon nanotubes were grown inside an alumina matrix using a catalyst and a carbon source. See Hamed Parham et al, Preparation of porous alumina-carbon nanotube composites via direct growth of carbon nanotubes; Composites Science and Technology Volume 71, Issue 15, 24 October 2011, Pages 1739-1745, incorporated herein by reference in its entirety. They applied the same technique to develop a ceramic/CNT composite filter for the removal of yeast and heavy metal ions (Fe, Cu, Zn, Mn) from water. The filter consisted mainly of alumina and silica, had a pore size ranging from 300 to 500 μm, and showed high efficiency for both yeast filtration (98%) and heavy metal ion removal (˜100%). See Hamed Parham et al, A highly efficient and versatile carbon nanotube/ceramic composite filter; Carbon Volume 54, April 2013, Pages 215-223, incorporated herein by reference in its entirety. Ihsanullah et al. reported the fabrication of silver-doped carbon nanotube membranes through a powder metallurgical method. CNTs were compacted at 200 MPa and sintered at 800° C. for 3 h after impregnation with silver through a wet chemistry technique. The synthesized membranes were used to remove bacteria from water, and the 10% silver-doped membrane achieved 100% bacterial removal in 60 min. See Ihsanullah et al, Novel anti-microbial membrane for desalination pretreatment: A silver nanoparticle-doped carbon nanotube membrane; Desalination 376 (2015) 82-93, incorporated herein by reference in its entirety. Other groups have also used nanoparticles or carbon nanotubes as adsorbents; see Sharma et al, Alumina Nanoparticles for the Removal of Ni(II) from Aqueous Solutions; Ind. Eng. Chem. Res. 2008, 47, 8095-8100; M. J. Santos Yabe, E. de Oliveira; Heavy metals removal in industrial effluents by sequential adsorbent treatment; Adv. Environ. Res., 7 (2003), pp. 263-272; and X Ren, C Chen, M Nagatsu, X Wang; Carbon nanotubes as adsorbents in environmental pollution management—Chemical Engineering Journal, 2011; Ihsanullah et al, Fabrication and antifouling behaviour of a carbon nanotube membrane; Materials and Design 89 (2016) 549-558.

Alumina and CNTs were studied individually as the absorbents in the literature. However, more efforts are needed to diversify the possibilities of development of their composites with enhanced properties.

Accordingly, it is one aspect of the present invention to provide a porous alumina-CNT nanocomposite membrane with suitable porosity and strength for water treatment applications such as the removal of heavy metals such as cadmium from an aqueous solution. In another aspect the nanocomposite membrane may be prepared by a powder metallurgical technique. In particular a composite powder mixture can be prepared and compacted via uniaxial pressing and subsequent consolidation through pressure-less, solid-state sintering.

### BRIEF SUMMARY OF THE INVENTION

In various embodiments the invention is directed to durable alumina-carbon nanotube membranes and methods for making them using spark plasma sintering by sintering procedures such as uniaxial compression and pressureless sintering. Methods for removing heavy metals or toxic levels of metals such as cadmium, chromium, arsenic, or mercury from waste water using alumina-carbon nanotube membranes or filters are disclosed. Other heavy or toxic metals that may be removed include lead, nickel, aluminum, antimony, barium, bismuth, copper, gandolinium, gallium, germanium, iron, palladium, platinum, plutomium, phodium, tellurium, thallium, thorium, tin, titanium, tungsten, uranium and zinc.

In one embodiment a porous alumina-carbon nanotube membrane comprises at least about 90 wt. % Al₂O₃ and between about 0.5 wt. % and about 5 wt. % carbon nanotubes.

In another embodiment the porous alumina-carbon nanotube membrane of embodiment 1 that comprises a ceramic matrix comprising Al₂O₃.

In another embodiment the porous alumina-carbon nanotube membrane of embodiment 1 does not contain one or more of zircon, tin, phosphorous, magnesium, yttrium, barium, and/or tantalum.

In another embodiment the porous alumina-carbon nanotube membrane of embodiment 1 that consists of sintered Al₂O₃ and carbon nanotubes.

In another embodiment the porous alumina-carbon nanotube membrane of embodiment 1 that is further functionalized by at least one ligand that binds to a metal. Functionalization is known in the art and incorporated by reference to M. A. Barakat: Arabian Journal of Chemistry Volume 4, Issue 4, October 2011, Pages 361-377; and to Dharani, et al. IJSRD—International Journal for Scientific Research & Development, Vol. 3, Issue 09, 2015 ISSN (online): 2321-061.

In another embodiment the porous alumina-carbon nanotube membrane of embodiment 1 that is produced by conventional sintering.

In another embodiment the porous alumina-carbon nanotube membrane of embodiment 1 that is produced by uniaxially pressing the mixture and by pressureless sintering.

In another embodiment the porous alumina-carbon nanotube membrane of embodiment 1 that is produced by sintering in a tube furnace and not by spark plasma sintering.

In another embodiment the porous alumina-carbon nanotube membrane of embodiment 1 that is produced by spark plasma sintering (“SPS”).

In another embodiment the porous alumina-carbon nanotube membrane of embodiment 1 that is produced by spark plasma sintering performed at a pressure of 8 to 12 MPa, a temperature of 1,000 to 1,100° C., a heating rate of 180 to 220° C./min, and a holding time of 5-15 mins.

In another embodiment the porous alumina-carbon nanotube membrane of embodiment 1 that is formed by sintering a mixture of the Al₂O₃ and carbon nanotubes and at least one pore former in an amount ranging from 0.1 to 10 wt. % and dispersant in an amount ranging from 0.1 to 10 wt. % of the mixture that is sintered.

In another embodiment the porous alumina-carbon nanotube membrane of embodiment 1 that is formed by sintering a mixture of the Al₂O₃ and carbon nanotubes and at least one pore former that is starch and dispersants that are gum Arabic and sodium dodecyl sulfate.

Another embodiment includes a filter comprising the porous alumina-carbon nanotube membrane of embodiment 1.

Another embodiment includes a method for making a porous alumina-carbon nanotube membrane comprising sintering a mixture comprising at least 90 wt. % Al₂O₃ and between about 0.5 wt. % and about 5 wt. % carbon nanotubes.

In another embodiment of the method the mixture comprises at least 90 wt. % Al₂O₃ and between about 0.5 wt. % and about 5 wt. % carbon nanotubes and does not contain one or more of zircon, tin, phosphorous, magnesium, yttrium, barium, and/or tantalum.

In another embodiment of the method the mixture consists of at least 90 wt. % Al₂O₃ and between about 0.5 wt. % and about 5 wt. % carbon nanotubes.

In another embodiment of the method the sintering comprises spark plasma sintering. In another embodiment of the method the sintering consists of spark plasma sintering (SPS) performed at:
a pressure of about 5.6 to about 20 MPa (including 6, 7, 8, 9, 10, 11, 12, 13, 14, 15, 16, 17, 18, 19 and 20),
a temperature of about 1,000 to, about 1,200° C. (including 1,025, 1,050, 1,075, 1,100, 1,125, 1,150, 1,175, and 1,200° C.),
a heating rate of about 50 to about 200° C./min (including 50, 60, 70, 80, 90, 100, 110, 120, 130, 140, 150, 160, 170, 180, 190 and 200° C.), and
a holding time of about 2.5 to about 10 mins.

In another embodiment of the method sintering comprises conventional sintering.

In another embodiment of the method the mixture is uniaxially pressed and then pressurelessly sintered.

In another embodiment of the method the sintering is performed in a tube furnace and is not spark plasma sintering.

Another embodiment includes a method for removing cadmium from water comprising contacting an aqueous solution containing cadmium, which has a pH ranging from 5.5 to 8.5 (including pH 5.5. 6, 6.5, 7, 7.5, 8, and 8.5), by contacting the aqueous solution with a porous alumina-carbon nanotube membrane that comprises at least about 90 wt. % Al₂O₃ and between about 0.5 wt. % and about 5 wt. % carbon nanotubes, and recovering water from which cadmium has been removed.

Another embodiment of the method further comprises repeating the contacting step with the water from which cadmium has been removed at least 1, 2 or 3 more times, optionally with the same or a different porous alumina-carbon nanotube membrane.

In another embodiment of the method the aqueous solution containing cadmium is wastewater containing more than 5, 10, 15, 20, 50, 100, or ≥200 μg/of cadmium.

In another embodiment of the method the aqueous solution containing cadmium is drinking water or irrigation water containing more than 1, 2, 5, 10, 15, 20, 50, 100, or ≥200 μg/of cadmium; and optionally repeating said contacting with the same or a different porous alumina-carbon nanotube filter until the recovered water has no more than 1 μg/L of cadmium.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1. Schematic diagram of the flow loop module. See Al Amer, Adnan M., Tahar Laoui, Aamir Abbas, Nasser Al-Aqeeli, Faheemuddin Patel, Marwan Khraisheh, Muataz Ali Atieh, and Nidal Hilal. Fabrication and antifouling behaviour of a carbon nanotube membrane. Materials & Design 89 (2016): 549-558, incorporated herein by reference in its entirety.

FIGS. 2A and 2B. FE-SEM images of as-received (FIG. 2A) α-alumina and (FIG. 2B) CNTs.

FIG. 3. XRD patterns of (a) as-received CNTs, (b) as-received α-alumina, and (c) sample sintered at 10 MPa, 1100° C., 5 min, and 200° C./min.

FIGS. 4A-4D. Changes in membrane porosity and permeability with varied SPS processing conditions: (FIG. 4A) pressure, (FIG. 4B) heating rate, (FIG. 4C) holding time, and (FIG. 4D) temperature.

FIGS. 5A-5D. Changes in pure water flux under different transmittance pressures for membranes prepared with varying SPS processing conditions: (a) pressure, (b) heating rate, (c) holding time, and (d) temperature.

FIGS. 6A-6F. FE-SEM of the membrane sintered at different conditions. FIG. 6A: 5.6 MPa, 1000° C., 10 min, and 100° C./min; FIG. 6B: 10 MPa, 1000° C., 10 min, and 100° C./min; FIG. 6C and FIG. 6D: 10 MPa, 1100° C., 5 min, and 200° C./min; FIG. 6E and FIG. 6F: 10 MPa, 1000° C., 10 min, and 50° C./min.

FIGS. 7A-7C. Diametrical compression testing. FIG. 7A: configuration. FIG. 7B: sample before the test. FIG. 7C: sample after the test.

FIG. 8. Permeability and strength of alumina-CNT membranes produced under different SPS conditions.

FIG. 9. Flow chart of the alumina/CNT membrane synthesis process.

FIG. 10. Flow loop system used for the water flux measurements and cadmium removal tests.

FIGS. 11A-11C. FIG. 11A: Schematic illustration of diametrical compression test. FIG. 11B: Alumina-CNT membrane before compression test. FIG. 11C: Alumina-CNT membrane after compression test.

FIGS. 12A-12B. FIG. 12A: XRD patterns of (i) CNTs, (ii) alumina, and (iii) alumina/CNTs powder mixture with a 5 wt. % CNT content. FIG. 12B: XRD patterns of the membranes (i) C50T1400 (ii) C100T1400 (iii) C150T1400 (iv) C200T1400.

FIGS. 13A and 13B. FIG. 13A: FE-SEM micrographs of as-received α-alumina powder. FIG. 13B: FE-SEM micrograph of as-received CNT powders.

FIGS. 14A-14D. SEM surface images of the membrane samples (FIG. 14A) C50T1200, (FIG. 14B) C50T1300 (FIG. 14C), C50T1400, (FIG. 14D) C50T1500. The increase in alumina particle size was observed with increase in sintering temperature.

FIGS. 15A and 15B. Sintering temperature dependence of porosity (FIG. 15A) and strength (FIG. 15B) for membranes (C50T1200, C50T1300, C50T1400, C50T1500) synthesized at a compaction load of 50 kN.

FIGS. 16A-16D. FE-SEM surface images of membranes samples FIG. 16A: C₅₀T1400; FIG. 16B: C₁₀₀T₁₄₀₀; FIG. 16C: C₁₅₀T₁₄₀₀, FIG. 16D: C₂₀₀T₁₄₀₀.

FIGS. 17A-17D. FE-SEM surface images of membranes compacted at C₅₀T₁₅₀₀ (FIG. 17A), C₁₀₀T₁₅₀₀ (FIG. 17B), C₁₅₀T₁₅₀₀ (FIG. 17C), C₂₀₀T₁₅₀₀ (FIG. 17D).

FIGS. 18A-18B. Compaction load dependence of porosity (FIG. 18A) and strength (FIG. 18B) for membranes synthesized at sintering temperatures of 1400 and 1500° C. The green dashed circle highlights samples with similar porosity and strength, discussed in the text. The error bar represents the standard deviation which was collected by the mean of three experimental values.

FIGS. 19A-19B. Pressure-related water flux behavior of membranes synthesized at different compaction loads, at sintering temperatures of 1400° C. (FIG. 19A) and 1500° C. (FIG. 19B).

FIG. 20. Effect of pH on Cd²⁺ removal by alumina and CNT adsorbents as measured in batch adsorption experiments. The quantity plotted in each case is the residual Cd⁺² concentration in the filtrate.

FIG. 21. Zeta potential of alumina and CNT powders as a function of pH.

### DETAILED DESCRIPTION OF THE INVENTION

Nanocomposite.

The nanocomposite of the invention comprises both alumina (Al₂O₃) and carbon nanotubes. Preferably the nanocomposite will be produced using Al₂O₃ particles. After sintering a nanocomposite will preferably consist of alumina and carbon nanotubes. However, in some embodiments various reinforcements may be incorporated. These include graphite, graphitic carbon, soots, zircon powder, tin oxide, phosphorous (such as phosphoric acid), magnesium, yttrium (such as yttrium oxide), barium, and tantalum (such as tantalum pentoxide).

A nanocomposite may be further functionalized either during or after sintering.

A nanocomposite may be cast or otherwise shaped into a form of a separation membrane or filter, such as a water filter. Such a filter may, or may not, include other elements, such as a metallic or non-metallic support layer, such as a later containing stainless steel, iron, metallic aluminum or other metals, or other inorganic or organic substrates.

Alumina.

The nanocomposite of the invention contains about 75, 80, 85, 90, 95 or <100 wt % alumina or Al₂O₃. In some embodiments other fillers or diluents, such as zirconia, cerium oxide, SiC or silica, including pyrogenic silica, may be admixed with the alumina. Preferable starting materials for producing a sintered nanocomposite include alpha-alumina powder having about a 0.1, 0.2, 0.3, 0.4 or 0.5 μm particle size.

Carbon Nanotubes.

The nanocomposite of the invention contains carbon nanotubes, generally multiwalled carbon nanotubes (“MWCNTs”). Carbon nanotubes may be single walled, double walled, or multi-walled carbon nanotubes, or a combination thereof. Advantageously the nanocomposite will contain about 0.1, 0.2, 0.5, 1.5, 2, 2.5, 3, 3.5, 4, 4.5 to about 5 wt. % carbon nanotubes. However, in some embodiments, the content of carbon nanotubes may be increased to exceed 5 wt. %, such as ≥5, 10, 15, 20, 25, 30, 35, 40, 45, 50, 55, 60, 65, 70, or 75 wt. % carbon nanotubes. Preferably, purified multiwall carbon nanotubes (MWCNTs) will have an outer diameter ranging from <1. 1, 2, 3, 4, 5, 6, 7, 8, 9, 10, 11, 12, 13, 14, 15, 20, 25, 30, 35, 40 or >40 nm, preferably within the range of about 5-25 nm; and lengths ranging from <1, 1, 2, 5, 10, 15, 20, 25, 30, 35, 40, 45, 50 or >50 nm, preferably within the length range of about 5 to 35 nm. In some embodiments carbon nanotubes may be impregnated with alumina, for example, by deposition of alumina nanoparticles on the CNT surfaces prior to sintering.

Presintering Mixtures.

Alumina, carbon nanotubes, and other ingredients to be sintered may be comminuted, mixed and dried prior to sintering. One or more pore forming agents or dispersants may be included in such a mixture prior to sintering. A pore forming agent (e.g., starch) or dispersant (e.g., gum Arabic or sodium dodecyl sulfate) may be present in an amount ranging from <1, 1, 1.5, 2, 2.5, 3, 3.5, 4.5, 5 or >5 wt. % based on the weight of a mixture to be sintered (e.g., prior to addition of distilled water add in some embodiments prior to sonication). In some embodiments one or more binders may be added to a mixture of ingredients prior to sintering, for example, a polyvinyl alcohol binder may be added to a nanocomposite power prior to spark plasma sintering. Binders include, but are not limited to, paraffin waxes, stearic acid, ethylene bis-stearamide (EBS), ethylene vinyl acetate, plasticizers (such as polyvinyl alcohol, polyethylene glycol, or synthetic resins), and the like. Pore forming agents, dispersants and binders are generally burned off during subsequent sintering.

Sintering.

Conventional sintering and spark plasma sintering may be used to produce the membranes of the invention. Other sintering or compaction methods such as hot extrusion process, liquid phase sintering, hot pressing, hot isostatic pressing, sinter-HIP, spark plasma sintering, sinter forging, microwave, or rapid omnidirectional consolidation may also be used for some embodiments. In some embodiments the membrane will be produced by sintering its components under a vacuum or at ambient air pressure, and in others the sintering may be performed under pressure or during compaction of the materials. Sintering may be performed in the presence or absence of oxygen, such as under a nitrogen, argon, or hydrogen atmosphere or in a reducing atmosphere.

Spark plasma sintering temperatures include, but are not limited to ≤800, 900, 1,000, 1,100, 1,200, 1,300, 1,400 or ≥1,500° C. Sintering pressures include but are not limited to ≤1, 2, 5, 10, 15, 20, 25, 30, 35, 40, 45, ≥50 mPa, preferably in the range of 2.5 to 15 Mpa. Heating rates include but are not limited to 25, 50, 100, 150, or 200° C./min. Holding times include, but are not limited to ≤1, 2, 2.5, 3, 3.5, 4, 4.5, 5, 6, 7, 8, 9, 10, 11, 12, 13, 14, 15, and >15 min.

Conventional, Non-spark plasma sintering conditions include, but are not limited to, methods that press or otherwise compact an alumina-carbon nanotube mixture (e.g., by uniaxial pressing) and then apply pressureless sintering (sintering of a compact powder without applied pressure). Compaction load of such a procedure may range from about ≤50, 60, 70, 80, 90, 100, 110, 120, 130, 140, 150, 160, 170, 180, 190, 200, 220, 230 or ≥230 kN. Sintering temperature may range from about ≤1,000, 1,100, 1,200, 1,300, 1,400, 1,500, or ≥1,600° C.

Cadmium is a toxic heavy metal contaminant in waste water, such as waste water from mining, smelting and other industrial operations. It is often present in sewage sludge and may leach into the environment by burning of oil, fossil fuels or municipal waste. It may leach into the water supply from waste disposal sites. Cadmium concentration in unpolluted waters are usually below 1 microgram/L. Cadmium may also be released in drinking water when present as an impurity in galvanized pipes or cadmium-containing solders if fittings, water heaters, water coolers and taps. In Saudi Arabia mean concentrations of 1-26 micrograms/L were found in samples of potable water. However, foods grown in solids polluted or irrigate with cadmium-polluted water are often the main sources of cadmium intake; see Cadmium in Drinking Water, WHO Guidelines for Drinking-water Quality; http://_www.who.int/water_sanitation_health/dwq/chemicals/cadmium.pdf (last accessed Apr. 12, 2018, incorporated by reference). In some embodiments, a membrane produced using the Alumina-CNT material of the invention can remove at least 10, 20, 30, 40, 50, 60, 70, 80, 90, 91, 92, 93, 94, or ≥95% of cadmium or other heavy metals such as Fe, Cr, Pb, Ni, Cu, and Zn in cadmium-containing water in a single passage. When ingested, cadmium exerts a variety of undesired effects on the respiratory system, cardiovascular system, renal system, and bones (e.g., causing osteoporosis). Cadmium crosses the placenta and can cause damage or death to a fetus. In some embodiments of the invention, a filter comprising a nanocomposite as disclosed herein is used to reduce cadmium content contaminated water to below 10, 9, 8, 7, 6, 5, 4, 3, 2, 1, or ≤0.5 microgram/L.

In some embodiments, ceramic alumina particles in a sintered composite will have an average grain size of no more than about 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2 μm.

In some embodiments, the average pore sizes in the nanocomposites may range from ≤0.025, 0.05, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, or to about 1 μm.

In some embodiments, the porosity of the nanocomposite or a nanocomposite membrane may range from about 5, 10, 20, 30, 40, 50, or to about 60% and permeability of the nanocomposite may range from about 5, 10, 11, 12, 13, 14, 15, 20, 25, 30, 35, 40, 45 to about 50.

Membrane thickness may be selected based on the formulas disclosed herein. Thickness may range from ≤1, 2, 3, 4, 5, 6, 7, 8, 9, 10, 15, to 20 μm or more.

As disclosed herein, a particular microstructure, which is characterizable by pore size and grain size, may be attained by selection of spark plasma sintering pressure with a higher pressure producing a nanocomposite having larger alumina particle sizes and a denser microstructure due to crystal growth. Selection of spark plasma sintering compared enables the production of a finer pore structure and a higher strength nanocomposite compared to conventional sintering by reducing sintering temperature and shortening sintering time.

Diametrical strength of spark plasma sintered material may range from about ≤3, 3.5, 4, 4.5, 5, 5.5, 6, 6.5, 7, 7.5, 8, 8.5, 9, 9.5, 10, 10.5, 11, 11.5, 12, 12.5, to ≥13 MPa. As disclosed herein, a particular diametric strength may be attained by careful selection of spark plasma sintering temperature and pressure because high pressure brings particles closer together during sintering and high temperature facilitates diffusion of adjacent particles together. Diametrical strength may be determined by diametrical compression testing using a universal testing machine (INSTRON) to investigate the strength of the developed membrane and then calculating the diametrical strength from the equation σ=(2 P/π Dt), where P is the load, D is the diameter, and t is the thickness of the membrane; David C. Cranmer, Mechanical testing methodology for ceramic design and reliability, Published by CRC Press; 1st edition (Feb. 1, 1998).

Permeability of the nanocomposite of the invention may range from ≤5, 10, 15, 20, 25, 30, 35, 40, 45, or ≥50 permeability of K/m₂.hr.bar.

Ceramic membranes are a type of artificial membranes made from inorganic materials (such as alumina, titania, zirconia oxides, silicon carbide or some glassy materials). They are used in membrane operations for liquid filtration. One aspect of the invention is the nanocomposite in the form of a ceramic membrane.

Another related aspect of the invention involves a water filter for the removal of cadmium from aqueous solutions containing it, including waste water and drinking water. The membrane or filter consists or comprises an alumina-CNT nanocomposite of the invention. It may further comprise other elements such as other active elements that bind to or degrade undesired contaminants or elements that make it electrically conductive or non-conductive.

The membrane may include support elements or substrates which may be next to, layered on, or laminated to a nanocomposite of the invention. The support is generally a thick, very porous structure that provides mechanical strength to the membrane element without significant flow resistance. The support may be composed of ceramics, glass ceramics, glasses, metals, and combinations thereof. Examples of these include, but are not limited to: metals, such as stainless steel alloys, metal oxides, such as alumina (e.g., alpha-aluminas, delta-aluminas, gamma-aluminas, or combinations thereof), cordierite, mullite, aluminum titanate, Mania, zeolite, ceria, magnesia, silicon carbide, zirconia, zircon, zirconates, zirconia-spinel, spinel, silicates, borides, alumino-silicates, porcelain, lithium alumino-silicates, feldspar, magnesium alumino-silicates, and fused silica. Nominal pore size of the support typically ranges from about 1 to about 10 μm, and in some embodiments, less than about 1 μm, particularly less than about 800 nm.

Such membranes or filters may incorporate or contain other active components known in the art such as adsorbents or catalysts useful for capturing or degrading other contaminants in an aqueous solution to be treated, including lead, antimony, arsenic, barium, other heavy metals, organic compounds, chlorine, chloramine, bromine, trihalomethanes, and/or microorganisms; as well as any other contaminants named by the Environmental Protection Agency; see https://_www.epa.gov/ground-water-and-drinking-water/national-primary-drinking-water-regulations (last accessed Apr. 12, 2018; incorporated by reference).

These membranes or filters may be used to treat industrial wastewater, municipal drinking water, or may be configured for use in the home, such as a whole-house water filter system, a refrigerator water filter, a filter for a single tap or water line, or a modular filter for use in a pitcher or water disperser. Preferably, these filters will remove 10, 20, 30, 40, 50, 60, 70, 80, 90, 91, 92, 93, 94, or ≥95% of cadmium in cadmium-containing water (or other heavy metal contaminant) in a single passage.

Membrane comprising the nanocomposite of the invention may be non-conductive or electrically conductive, such as one containing an electrically conductive metal or non-metallic material, such as particles from 10 to 200 microns in diameter.

A membrane according to the invention can incorporate, be coated with, or otherwise functionalized with one or more catalysts including metal oxides, such as iridium oxide, titanium oxide, molybdenum oxide, vanadium oxide, or niobium oxide. For example, a membrane according to the invention may include or be functionalized with titanium oxide to facilitate photocatalytic treatment of waste water; see Lazar, et al., Catalysts 2012, 2, 572-601; doi:10.3390/cata12040572 (incorporated by reference).

### EXAMPLES

The following examples illustrate various aspects of the present invention. They are not to be construed to limit the claims in any manner whatsoever.

### Example 1

### Influence of Spark Plasma Sintering Parameters on the Properties of Alumina-CNT Nanocomposite Membranes

As disclosed in Example 1, the use of spark plasma sintering (SPS) to fabricate porous alumina-carbon nanotube (Al₂O₃-CNT) nanocomposite membranes is reported for the first time. The effects of SPS processing parameters (pressure, temperature, heating rate, and holding time) on the porosity, water flux, and permeability of the developed membrane are disclosed. A nanocomposite powder of alumina containing 5 wt. % CNTs was prepared with the addition of starch as a pore former and gum arabic and sodium dodecyl sulfate as dispersants. This nanocomposite powder was then sintered using SPS to produce solid nanocomposite membranes. The structure and microstructure of the membranes were characterized using X-ray diffraction (XRD) and field emission scanning electron microscopy (FE-SEM). The performance of the membranes was evaluated by measuring their porosity, permeability, and mechanical properties. The results revealed that the CNTs were distributed well (e.g., homogeneously) within the alumina matrix and located mainly at the alumina grain boundaries. The permeability and strength were highly influenced by the sintering pressure and temperature, respectively. A membrane sintered at a pressure of 10 MPa, a temperature of 1100° C., a holding time of 5 min, and a heating rate of 200° C./min exhibited a highly advantageous combination of permeability and strength consistent with industrial usage such as for application for water filtration.

Experimental Methods

Raw Materials and Preparation of Nanocomposite Powder.

The nanocomposite powder was prepared from a commercial α-alumina powder of 0.3 μm particle size supplied by Buehler (purity >95%) and purified multiwalled carbon nanotubes (MWCNTs) (for simplicity will just refer to them as CNTs.) with an outer diameter (OD) of 10-20 nm and a length of 10-30 μm supplied by Times Nano, China. Starch was used as pore former. Polyvinyl alcohol (PVA) was used as a binder material. Gum arabic (GA) and sodium dodecyl sulfate (SDS) were used as dispersants. The alumina-CNT nanocomposite powder was prepared by the following steps:

1. α-Alumina powder (95%) was mixed with 5% starch (binder and pore former).

2. CNTs (5 wt. %) were hand-mixed in 2 liters of distilled water containing 2.5% GA and 2.5% SDS and then subjected to probe sonication for 2 hrs.

3. The solutions from steps 1 and 2 were physically mixed, sonicated for 2 hrs., and then dried on a hot plate at 80° C. under continuous stirring for water evaporation. Then, the mixture was heated in an oven at 70° C. to dry the composite powder.

4. A fine powder was obtained by careful hand crushing.

5. The binder solution was prepared by heating 2% PVA in distilled water at 80° C. to obtain a clear solution.

6. A 10% binder solution was added to the nanocomposite powder for improved compaction.

Spark Plasma Sintering Operation.

After preparing the nanocomposite powder, a spark plasma sintering (SPS) machine (FCT system-model HP D5, Germany) was used to fabricate the porous alumina-CNT composite billets. A nanocomposite powder was added into a 30-mm graphite die, and a graphite sheet was used to facilitate the removal of the sample and to reduce the friction between the die walls and the powder. The experiments were conducted in a vacuum under a pressure (P) of 5, 10, or 20 MPa and at a sintering temperature (T) of 1000, 1100, or 1200° C., a heating rate (HR) of 50, 100, or 200° C./min, and a holding time (t) of 2.5, 5, or 10 min. A parametric study was conducted to investigate the effects of the SPS parameters on the membrane properties. Table 1 shows the different processing parameter sets and the assigned samples codes.

TABLE 1
SPS processing parameters, porosity, diametrical
strength, and permeability of SPS samples

| | | | | | Experimental Results | | |
|---|---|---|---|---|---|---|---|
| | | | | | | Dia- | |
| | Processing Parameters | | | | | metrical | |
| Sample | T | t | HR | P | Porosity | strength | Perme- |
| code | ⁽° C.) | (min) | (° C./min) | (MPa) | % | (MPa) | ability |
| SPS-1 | 1000 | 10 | 100 | 20 | 10.77 | 12.3 | 12.31 |
| SPS-2 | 1000 | 10 | 100 | 10 | 56.2 | 6.9 | 39.45 |
| SPS-3 | 1000 | 10 | 100 | 5.6 | 69.7 | 1.9 | NA |
| SPS-4 | 1000 | 10 | 50 | 10 | 33.2 | 8 | 35.34 |
| SPS-5 | 1000 | 10 | 200 | 10 | 60.7 | 4.9 | 44.58 |
| SPS-6 | 1000 | 5 | 200 | 10 | 67.5 | 4.1 | 41.32 |
| SPS-7 | 1000 | 2.5 | 200 | 10 | 69.3 | 3.4 | 45.86 |
| SPS-8 | 1100 | 5 | 200 | 10 | 64 | 9.5 | 37.89 |
| SPS-9 | 1200 | 5 | 200 | 10 | 50 | 10.4 | 20.53 |

Sintered Membrane Characterization.

The structure and phases of both the as-received raw materials and SPS samples were characterized by X-ray diffraction (XRD) using an AXSD8 Bruker machine with Cu-Kα radiation at a scanning speed of 1 degree/min. Field emission scanning electron microscopy (FE-SEM; TESCAN Lyra-3) was used to study the as-received raw materials and the microstructure, particle size, and pore size of the SPS samples. The porosity of the developed membrane was measured according to ASTM C373-14a. The diametrical compression testing was performed using a universal testing machine (INS TRON) to investigate the strength of the developed membrane. The diametrical strength was then calculated from the equation σ=(2 P/7(Dt), where P is the lead, D is the diameter, and t is the thickness of the membrane; David C. Cranmer, “Mechanical testing methodology for ceramic design and reliability”, Published by CRC Press; 1 edition (Feb. 1, 1998).

Water Flux Measurement.

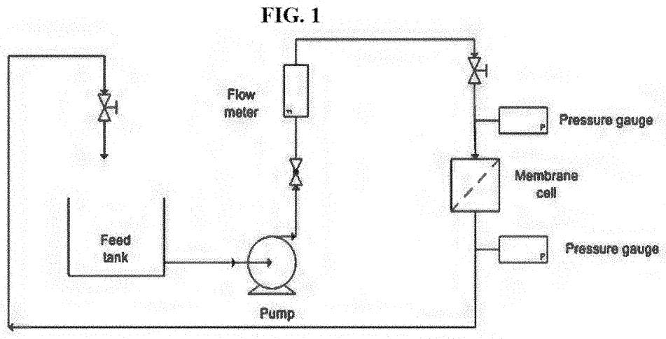

The water flux measurements were performed using a flow loop module built in-house, as previously described (FIG. 1), and the water flux (J) was determined using the equation J=V/At, where V is the volume of the permeate water, A is the effective area of the membrane, and t is the time required for a specific amount of water to permeate. The water flux was measured under a transmembrane pressure of 5-40 psi. The water permeability of the membranes was calculated at transmembrane pressure (P) of 40 psi by dividing the water flux (J) to the transmembrane pressure value. FIG. 1 provides a schematic diagram of the flow loop module.

Characterization of Starting Materials and Sintered Samples.

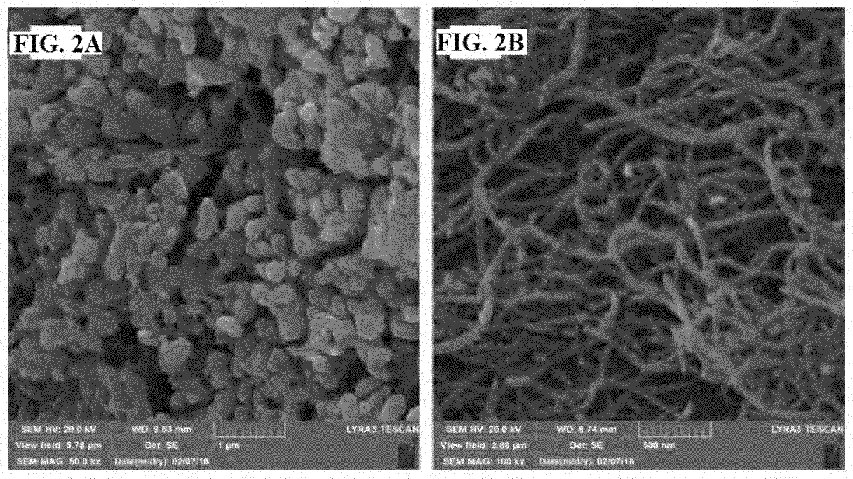

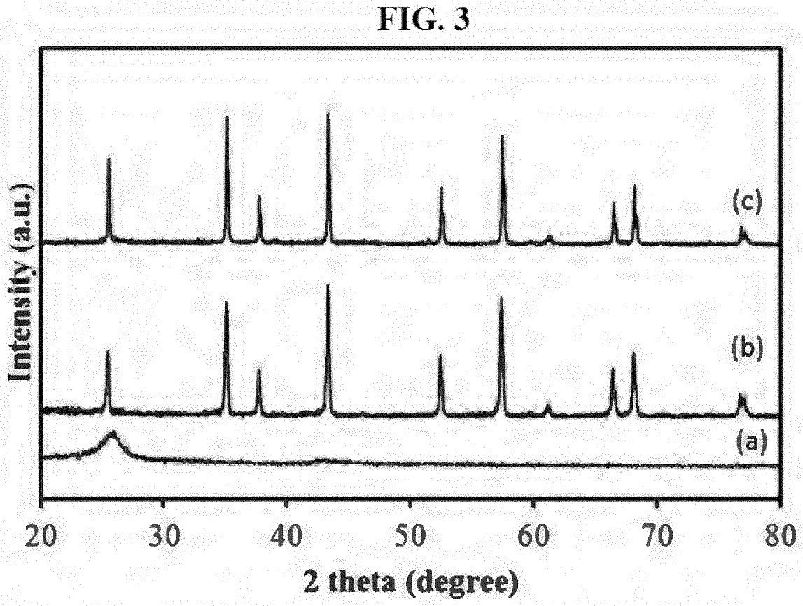

The starting materials were examined by FE-SEM and XRD to confirm their structure and microstructure. FE-SEM images show that the as-received alumina has a uniform particle size of 0.3 μm (FIG. 2A), which agrees with the supplier data. Moreover, the image clearly shows little variation among the particles, which is important for controlling the pore size. The MWCNTs had an outer diameter (OD) of 10-20 nm (FIG. 2B). The XRD spectrum of the CNTs presented in FIG. 3A shows two peaks corresponding to 2-theta values of 26° and 44°, which are correspond to the hexagonal graphite lattice of the MWCNTs. FIG. 3B shows the XRD pattern of the as-received alumina with all of the expected peaks of high-purity α-alumina.

XRD was performed for all the sintered membranes to study the influence of the SPS parameters on the structure. FIG. 3 (c) shows the XRD pattern for a selected sample (which show best combination of strength and permeability) sintered at 10 MPa, 1100° C., 5 min, and 200° C./min. This spectrum contains only the peaks related to crystalline α-Al₂O₃ were observed; the same is true for the XRD spectra of all other samples in this study (not shown). The peaks related to the CNTs were not observed partly because it could be that alumina peaks overlap with the CNT peaks, which might make it impossible to show the CNT peaks in the composite spectrum because of the small quantity used (5%) compared with the highly crystalline matrix of the alumina. Most importantly, no extra phases or missing peaks were observed in any of the XRD spectra after SPS, which confirmed that no phase changes occurred during membrane formation and the final membranes all consisted of the desired crystalline α-Al₂O₃.

Effects of SPS Parameters on Porosity, Water Flux, and Permeability.

Permeability is the ability of water to move through the pores of membranes. Permeability is a function of both water flux and transmitting pressure. Permeability and water flux depend on the porosity of the membrane and the water flux will be higher for membrane with higher porosity. The influence of SPS parameters on porosity, water flux and permeability are presented below. The porosity was measured according to ASTM standard for ceramic materials (ASTM c373-14a). The water flux was measured using flow loop as in FIG. 1, then the permeability was calculated by dividing the water flux with the transmitting pressure.

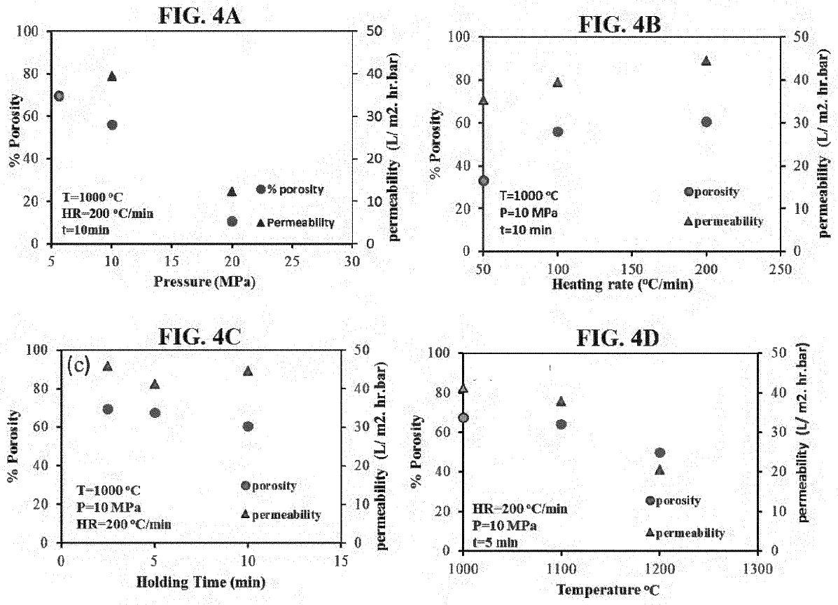

FIGS. 4A-4D shows the variation in porosity and permeability of the SPS samples with varied SPS processing conditions. The porosity decreased with increasing sintering pressure (FIG. 4A) and temperature (FIG. 4D). However, the porosity was influenced more by the sintering pressure (decreased from 69.7% at 5.5 MPa to 10.77% at 20 MPa) than the sintering temperature (67% at 1000° C. to 50% at 1200° C.). Both increased temperature and pressure contributed to the neck growth of the alumina particles, and thus decreased the porosity. The observed decrease in porosity with increased sintering pressure and temperature might be due to the sintering of adjacent particles. However, the porosity increased with the increase in the heating rate (FIG. 4B) (33% at 50° C./min to 69% at 200° C./min). The opposite effect was observed for the holding time. As the holding time is increased from 2.5 min to 15 min, the porosity decreased from 69.3% to 60.7% (FIG. 4C).

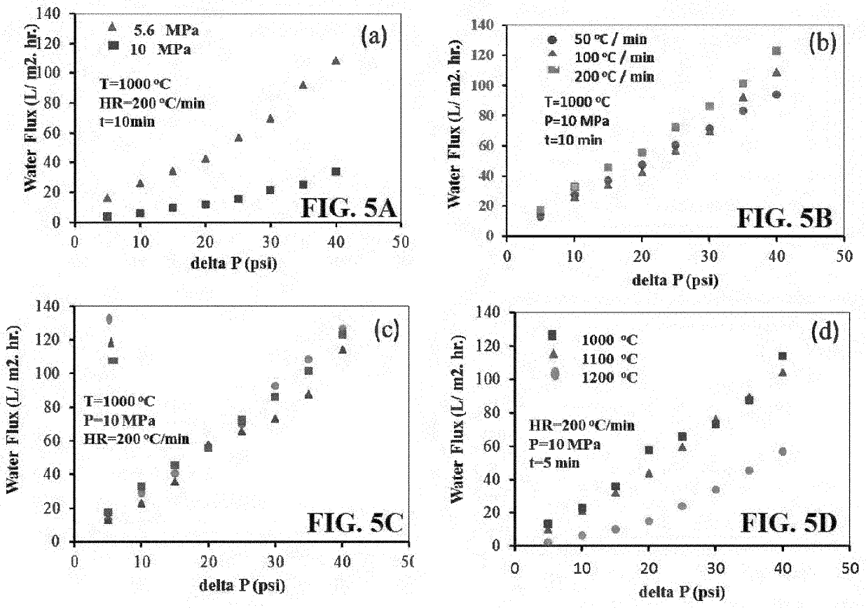

The water flux through the sintered samples was measured at a transmembrane pressure of 5-40 psi using the setup shown in FIG. 1. Generally speaking, water flux increased with increasing transmittance pressure for all conditions (FIGS. 5A-5D). The water flux was more influenced by the SPS pressure and temperature than by heating rate or holding time, which could be attributed to the porosity. The sample compacted at 5.6 MPa, which had the highest porosity of all samples, broke during the flux test, indicating that this compaction pressure yielded a membrane with low strength and that this processing pressure does not produce a sufficiently robust membrane for practical applications The membrane permeability for the different SPS processing conditions, which represents the membrane's productivity, was calculated from the water flux measurements. As shown in FIGS. 4A-4D, the membrane permeability follows a similar trend to that of the porosity for the different processing parameters: it decreases with increasing sintering temperature (decreased from 41.58 at 1000° C. to 20.53 at 1200° C.) and pressure, however, it increases with increasing heating rate that increased from 35.3 at 50° C./min to 44.5 at 200° C./min. The highest permeability of 45.86 and 44.5 was obtained for the samples sintered at 10 MPa, 1000° C., 2.5 min (SPS-7), and 200° C./min and 10 MPa, 1000° C., 10 min, and 200° C./min. (SPS-5) respectively.

Microstructural Characterization of Spark Plasma Sintered Membranes.

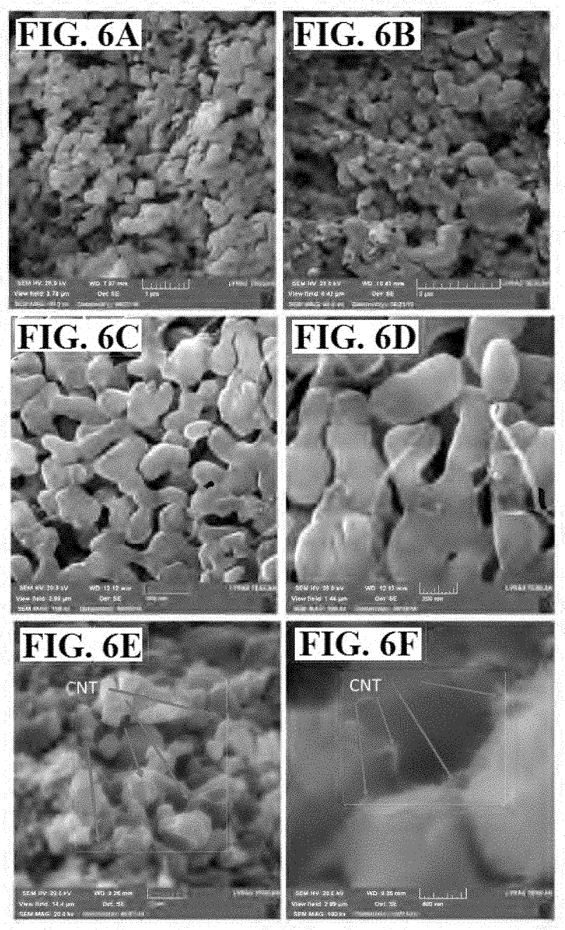

FE-SEM was performed to investigate the microstructure and pore size of selected samples. It was observed that the pore size and grain growth is affected by the SPS pressure as presented in FIGS. 6A and 6B. The SEM image of the membrane prepared using a sintering pressure of 5.6 MPa (FIG. 6A) shows insufficient cohesion between particles as the fine grains are very similar to those shown in the FE-SEM image of the as-received alumina starting material (FIG. 2A). Conversely, the membrane prepared using a higher pressure of 10 MPa (FIG. 6B) shows larger alumina particle sizes and a denser microstructure due to crystal growth, with the alumina particles showing neck growth with adjacent particles. This growth increased with increasing sintering pressure (FIGS. 6A and 6B) and temperature (FIGS. 6C and 6D). FIGS. 6E and 6F show a micrograph of the fractured surface of sample SPS-4. It shows that the CNTs are well distributed within the alumina matrix and located mainly along the grain boundaries. Therefore, the nanocomposite developed in this study appears to be intergranular. See K. Niihara, New Design Concept of Structural Ceramics Nanocomposites, J. Ceram. Soc. Jpn. 99 [10] 974-82 (1991), incorporated herein by reference in its entirety. Due to the simultaneous effects of pressure and temperature, SPS enables higher heating rates by shortening the sintering time thereby reducing the temperature compared with conventional sintering, which helps produce finer pores. Therefore, SPS could facilitate the production of higher-strength materials at lower temperatures compared with hot pressing and conventional sintering. See Deng, Z. Y., Fukasawa, T., Ando, M., Zhang, G. J. and Ohji, T., Microstructure and mechanical properties of porous alumina ceramics by the decomposition of aluminum hydroxide. J. Am. Ceram. Soc., 2001, 84, 2638-2644, incorporated herein by reference in its entirety. FIG. 6E and FIG. 6F show very low porosity and high particle growth, likely to be as a result of the low heating rate of 50° C./min used to prepare this membrane. The decreased heating rate caused slow sintering to occur, which contributed to an increase in particle growth and subsequently a decrease in the porosity. In addition, grain shape and morphology were also affected by this slower heating rate. While not being bound to any particular explanation, the sintering mechanism responsible for this effect may involve grain-boundary and volumetric diffusion. See R. M. German, in Sintering Theory and Practice, John Wiley & Sons, New York, 1996; C. Falamaki, M. S. Afarani, Aghaie, Initial sintering stage pore growth mechanism applied to the manufacture of ceramic membrane supports, J. Eur. Ceram. Soc. 24 (2004) 2285-2292, each incorporated herein by reference in its entirety.

Mechanical Properties of Al₂O₃-CNT Nanocomposite Membrane.

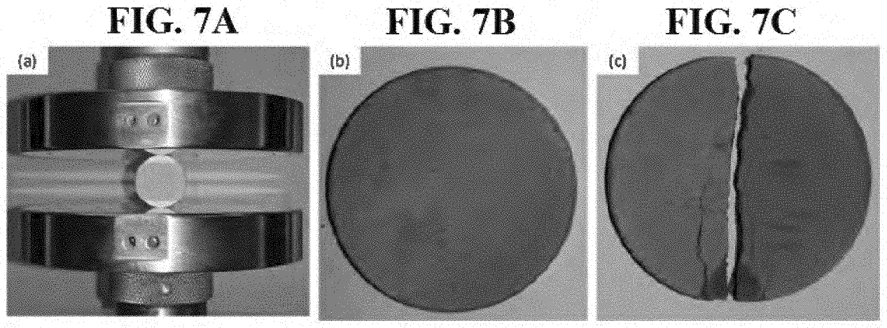

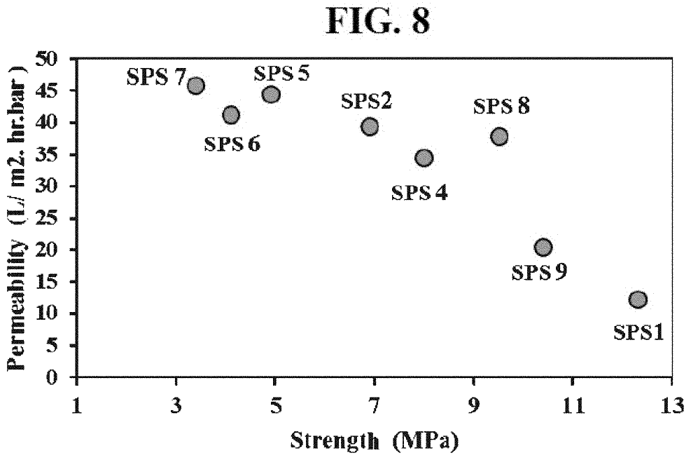

A diametrical compression test was used to measure the strength of each membrane; see FIG. 7. In each case, the test was completed when the sample fractured into two halves (FIG. 7C) as a result of tensile failure. See Patel et al. (2011); and David C. Cranmer, Mechanical testing methodology for ceramic design and reliability, Published by CRC Press; 1st edition (Feb. 1, 1998), each incorporated herein by reference in their entirety. Increasing the sintering temperature from 1000° C. to 1200° C. resulted in an increase in the diametrical strength of the SPS membrane from 1.9 MPa to 12.3 MPa (Table 1), which can be attributed to grain growth and pore shrinkage. Similar results were obtained with increasing pressure. Sample SPS-1 was sintered with a pressure of 20 MPa and showed a strength of 12.3 MPa, whereas SPS-3 was sintered at a pressure of 5.6 MPa and showed a strength of 1.92 MPa (Table 1). These findings reveal that SPS temperature and pressure both have a significant effect on the strength of the membrane. High pressure brings particles closer together during compaction, and high temperature causes them to diffuse with one another easily; this result is consistent with previous research; Barma, Sanjib, and Bishnupada Mandal. Effects of sintering temperature and initial compaction load on alpha-alumina membrane support quality. Ceramics International 40.7 (2014): 11299-11309. With other parameters held constant, the strength increased with increasing sintering pressure, which can be attributed to an increase in the densification of the membrane. This increase in densification reflects an increase in interface formation, which ensures effective load sharing between the matrix (Al₂O₃) and filler (CNTs), as confirmed by the FE-SEM micrograph shown in FIG. 8; these results are also consistent with previous studies; Barma, Sanjib, and Bishnupada Mandal. Effects of sintering temperature and initial compaction load on alpha-alumina membrane support quality. Ceramics International 40.7 (2014): 11299-11309; R. M. Spriggs, T. Vasilos, Effect of grain size on transverse bend strength of alumina and magnesia, J. Am. Ceram. Soc. 46 (5) (1963) 224-228. By contrast, the heating rate showed an antagonistic effect on strength. An increase in the heating rate from 50° C./min to 200° C./min resulted in a decrease in membrane strength from 8 MPa to 4.9 MPa. This reduction in strength can be attributed mainly to the higher porosity, producing a poorer interface with poorer load sharing.

Enhancing the Membrane Permeability and Strength.

It is important to analyze and correlate the properties of the developed Al₂O₃-CNT nanocomposite membrane with the processing parameters to obtain a membrane having both advantageous permeability and strength. The permeability is related to the productivity of the membrane, while the strength of the membrane plays a significant role in its reliability and service life. The permeability and strength of the membranes produced under different SPS conditions are presented in FIG. 8 and were used to identify the SPS conditions that yielded the best combination of permeability and strength. Membrane SPS-11 showed the optimal combination, followed by membranes 4 and 2. The average pore size was calculated from all the pores shown in the FE-SEM micrographs of selected samples. For SPS-11, the average value of pore size was 0.143±0.039 μm and ranged from 0.08 μm to 0.24 μm. The formation of the pores is attributed to both the burning off the pore former and partial sintering. See C. Falamaki et al.; and S. Ananthakumar, K. G. K. Warrier, Extrusion characteristics of alumina-aluminum titanate composite using boehmite as a reactive binder, J. Eur. Ceram. Soc. 21 (1) (2001) 71-78, each incorporated herein by reference in their entirety.

As shown by Example 1, porous alumina-carbon nanotube (Al₂O₃-CNT) nanocomposite membranes were fabricated for the first time by spark plasma sintering (SPS) technique. The CNTs were found to be well distributed throughout the alumina matrix and were located mainly along the alumina grain boundaries. By varying the processing parameters, membranes with best combination of strength and permeability were obtained. The porosity was observed to be more influenced by the sintering pressure, followed by the sintering temperature whereas the strength, water flux, and permeability of the membrane were more influenced by the sintering temperature, followed by the applied pressure. The sample prepared using a pressure of 10 MPa, a sintering temperature 1100° C., a holding time of 5 min, and a heating rate or 200° C./min showed a most advantageous combination of permeability of 37.8 L/m².hr.bar and strength of 9.5 MP and had an average pore size of 0.143 μm.

### Example 2

Example 2 discloses and exemplifies a simple approach for synthesizing an alumina-carbon nanotube (Al₂O₃-CNT) composite membrane through a powder metallurgical method. The membrane was fabricated via uniaxial pressing of the composite powder mixture and subsequent solid-state, pressure-less sintering. Homogeneous dispersion of the CNTs within the alumina matrix was achieved by using gum arabic and sodium dodecyl sulfate as dispersants. The phase composition and microstructure of the synthesized membrane were characterized using X-ray diffraction (XRD) and field emission scanning electron microscopy (FE-SEM), respectively. The effect of process parameters (i.e., initial compaction load and sintering temperature) on the porosity, strength, and water flux of the membrane was investigated, and the results highlighted a strong influence of the process parameters on these properties. In particular, when the compaction load and sintering temperature were increased from 50 to 200 kN and 1200 to 1500° C., the porosity of the membrane decreased from 65 to 31% and its strength increased from 0.76 to 15.64 MPa respectively. Batch adsorption experiments were used to determine the cadmium removal efficiency of the alumina and CNTs adsorbents, as well as that an Al₂O₃-CNT powder mixture, whereas the efficiency of the membrane based on the above mixture was assessed using a flow loop system. The membrane removed 93% of the Cd present in a water solution containing 1 ppm Cd at pH 6.

Materials.

Alumina powder (α-alumina, average particle size 0.3 μm) was obtained from Buehler, Ill., USA. Commercial MWCNTs were purchased from Times Nano, Chengdu Organic Chemicals Co., Ltd., China (purity >95%, outer diameter 10-20 nm, length 10-30 μm). Polyvinyl alcohol (PVA), used as a binder, along with gum arabic (GA) and sodium dodecyl sulfate (SDS), used as CNT dispersants, were purchased from Loba Chemie Pvt., Ltd. India.

Membrane Synthesis.

A powder metallurgical process was used to produce alumina-CNTs composite membranes. To avoid agglomeration, the CNTs were thoroughly dispersed in distilled water by adding GA and SDS in a 1:1 ratio, such that the CNTs accounted for a total 5% of the mixture, followed by probe sonication for 1 h. See Fawad Inam et al.

An alumina/starch mixture was also prepared. Starch (comprising 5 wt. % of the mixture) was used to promote pore formation in the alumina matrix. See O. Lyckfeld and J. M. F. Ferreirab. Processing of Porous Ceramics by Starch Consolidation. Journal of the European Ceramic Society, 18 (1998) 131-140; Li, Chang-An Wangn, Jun Zhou, Effect of starch addition on microstructure and properties of highly porous alumina ceramics Sa Ceramics International 39 (2013) 8833-8839, each incorporated herein by reference in their entirety. The alumina/starch powder mixture was added to the CNT/GA/SDS solution and further sonicated for 2 h to achieve homogeneous dispersion of all components.

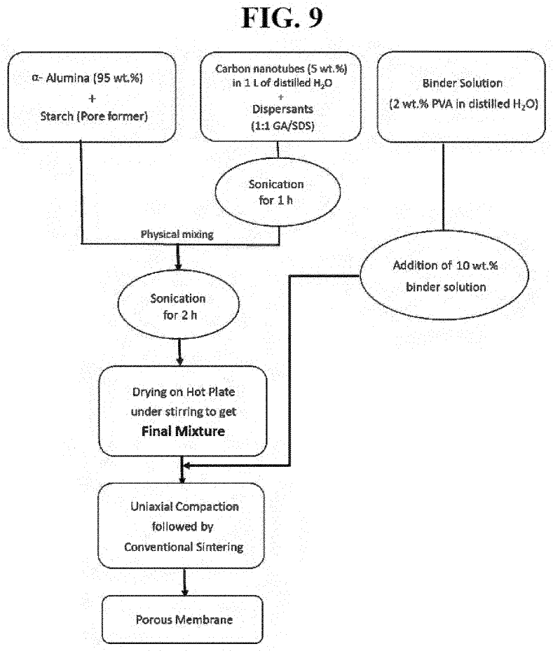

Water was then evaporated from the resulting alumina/CNT mixture by placing it on a hot plate under continuous stirring. Several drops of binder solution (prepared by adding 2 wt. %. PVA in distilled water) were added to dry the mixture and produce a thick paste ensuring a more effective compaction; see Sanjib Barma et al. FIG. 9 shows a flow chart of the mixture preparation process.

The alumina/CNT powder mixture was compacted into a disc-shaped membrane. The compaction was performed in a custom-made stainless steel die (diameter 27.5 mm), using a uniaxial pressing machine (Wabash, Ind., USA) to press the powder mixture into a disc with 4 mm thickness and 27.5 mm diameter. The powder was initially compacted at a 50 kN load with a dwell time of 3 min to achieve a porous green compacted disc; see Sanjib Barma et al. The compacted disc was sintered at four different temperatures (1200, 1300, 1400, and 1500° C.) in a tube furnace (GSL 1700X, MTI Corp., USA) to evaluate the effect of the sintering temperature on the properties of the final membrane; Sanjib Barma, Bishnupada Mandal. Effects of sintering temperature and initial compaction load on alpha-alumina membrane support quality. Ceramics International, 40 (2014) 11299-11309. S. Hashimoto et al, Synthesis and mechanical properties of porous alumina from anisotropic alumina particles; Journal of the European Ceramic Society Volume 30, Issue 3, February 2010, Pages 635-639.

A heating rate of 5° C./min was used throughout the heating cycle, while a holding time of 4 h at 500° C. was used to remove the GA, SDS, and PVA additives, and the disc was held for 2 h at the selected sintering temperature.

In another set of experiments, we assessed the effect of the compaction load on the porosity and mechanical strength of the membrane. The alumina/CNT mixture was compacted with increasing compaction loads (100, 150, and 200 kN) and sintered at two different temperatures, 1400 and 1500° C. (matching two of the temperatures selected in the first set of experiments), in order to identify the experimental conditions yielding a membrane with optimal strength and porosity. The synthesis conditions corresponding to the different samples and the properties of the corresponding membranes are detailed in Table 1b.

TABLE 1b
Experimental design matrix showing the synthesis conditions used to
prepare the different samples and the porosity, strength, and pore
size characteristics of the corresponding membranes.

| Process Parameters | | | Sample Properties | | |
|---|---|---|---|---|---|
| | Com- | Sintering | | Mechanical | Average |
| Sample | paction | Temperature | Porosity | Strength | Pore |
| No. | Load (kN) | (° C.) | (%) | (MPa) | Size (μm) |
| C₅₀T₁₂₀₀ | 50 | 1200 | 64.6 | 0.75 | 0.93 |
| C₅₀T₁₃₀₀ | 50 | 1300 | 61.9 | 1.75 | 0.69 |
| C₅₀T₁₄₀₀ | 50 | 1400 | 59.1 | 2.54 | 0.55 |
| C₁₀₀T₁₄₀₀ | 100 | 1400 | 49.5 | 5.55 | 0.47 |
| C₁₅₀T₁₄₀₀ | 150 | 1400 | 45.7 | 8.43 | 0.29 |
| C₂₀₀T₁₄₀₀ | 200 | 1400 | 39.9 | 11.07 | 0.15 |
| C₅₀T₁₅₀₀ | 50 | 1500 | 55.4 | 3.23 | 0.42 |
| C₁₀₀T₁₅₀₀ | 100 | 1500 | 46.6 | 7.87 | <0.2 |
| C₁₅₀T₁₅₀₀ | 150 | 1500 | 40.2 | 11.91 | <0.1 |
| C₂₀₀T₁₅₀₀ | 200 | 1500 | 31.3 | 15.64 | <0.05 |

Characterization.

Various characterization techniques were used to analyze the properties of the as-received alumina and CNT powders, of their mixture, and of the synthesized membranes. The structure of the powder materials and of the fabricated membranes was characterized by X-ray diffraction (XRD), using a Bruker D8 Advanced diffractometer operating at a scanning rate of 2°/min and a 20 range of 20° to 80°. The surface morphology and microstructure of the samples (average size of particles and pores) were analyzed by field emission scanning electron microscopy (FE-SEM, Tescan, lyra 3). Diametrical compression tests were performed with an INSTRON universal testing machine by placing the membrane disk between flat plates and pressing it at a crosshead speed of 0.05 mm/min.

Water Permeation Tests.

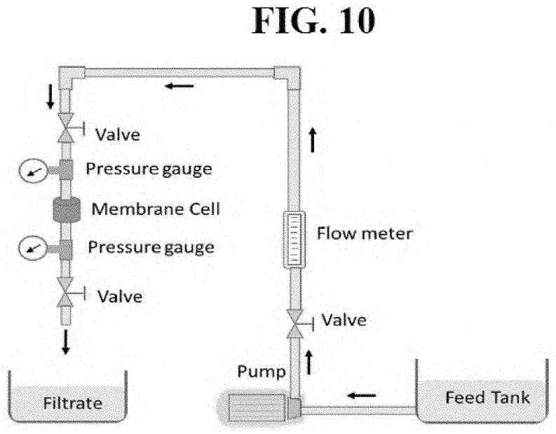

Water flux measurements were carried out using a custom-made flow loop system, schematically shown in FIG. 10. The pure water flux J (L m-2 h⁻¹) of the membrane at transmembrane pressures of 1-5 bar was calculated using Equation 1:

$$J = \frac{V}{A \times t}$$

where A (m²) is the surface area of the membrane and V (L) is the volume of water passing through the membrane in a certain time t (h). See Ihsanullah et al. (2015).

The water flux is generally a linear function of the transmembrane pressure: higher water pressures lead to faster water transport through the membrane and hence to increased permeability. See Ihsanullah et al. (2015). The same loop system was also utilized to perform the cadmium removal analysis.

Porosity Measurements. The porosity of the membranes was measured according to the ASTM standard for porous ceramic materials (ASTM C373-14a). See Standard Test Method for Water Absorption, Bulk Density, Apparent Porosity, and Apparent Specific Gravity of Fired Whiteware Products, Ceramic Tiles, and Glass Tiles, ASTM C373-14, 2014; and Dibyendu Chakravarty et al., High strength porous alumina by spark plasma sintering; Journal of the European Ceramic Society 29 (2009) 1361-1369, each incorporated herein by reference in their entirety. The wet and dry weights of the membrane were determined according to the procedures indicated in the standard, and the percent porosity of the membrane was then calculated using Equation 2:

$$V = M - S$$

$$P = [ \frac{( M - D )}{V} ] \times 100$$

where P is the apparent porosity, D is the dry weight, M is the saturated weight, S is the suspended weight, and V is the volume of the membrane.

Diametrical Compression Tests.

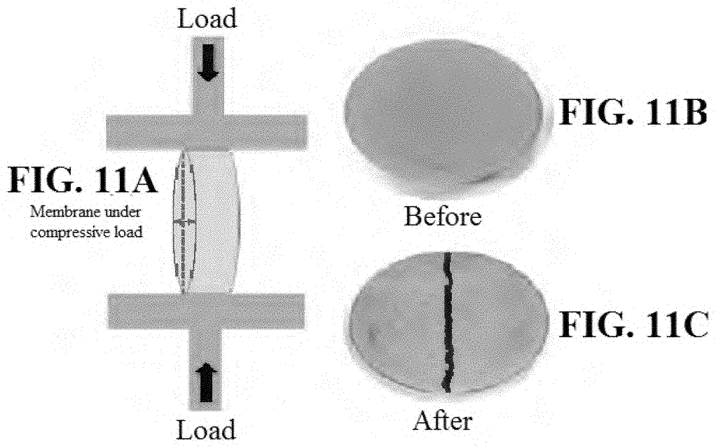

The mechanical strength of the porous ceramic membranes was evaluated using diametrical compression tests, as schematically illustrated in FIG. 11A. The membrane disc was arranged vertically along its diameter, such that tensile stress within the membrane developed in the direction perpendicular to the compressive load, causing the sample to break into two pieces. Fracture propagation through the center of the sample indicated successful test completion, as shown in FIG. 11B. The strength of the membrane (σ) was thus calculated according to Equation 3:

$$σ = \frac{2 L}{π dk}$$

where L is the applied load while D and k are the diameter and thickness of the membrane, respectively. See Faheemuddin Patel; and D. Cranmer and D. Richerson, Mechanical testing methodology for ceramic design and reliability. 1998, each incorporated herein by reference in their entirety.

Cadmium Removal Tests.

The USA EPA has established the maximum permissible concentration of cadmium in water is 0.005 ppm (mg/L). A 1 ppm solution of cadmium ions was prepared from a Cd standard solution (1,000 ppm) supplied by Ultra Scientific, USA and used for testing the Cd⁺² removal performance of the present materials. See Abbas, Aamir, et al. Heavy metal removal from aqueous solution by advanced carbon nanotubes: critical review of adsorption applications. Separation and Purification Technology 157 (2016): 141-161, incorporated herein by reference in its entirety. The cadmium removal efficiency of the individual Al₂O₃ and CNT components and of their mixture was assessed through batch adsorption experiments. In a batch test, a powder suspension with a concentration of 5 g/L was stirred in an orbital shaker at 150 rpm for 1 h. Blank tests on a cadmium-free solution were performed to evaluate the amount of Cd removed by adsorption on the container walls and by precipitation.

Afterwards, the cadmium removal efficiency of the selected alumina-CNT membrane was investigated using the flow loop system shown in FIG. 10. The filtrate from both the experiments (batch as well as flow loop) were than analyzed with an Optima-8000 ICP-OES system. All investigations were performed in triplicate, to improve the statistical accuracy of the results. The adsorption removal efficiency was calculated using Equation 4:

$$R ( \% ) = \frac{{C}_{0} - {C}_{t}}{{C}_{0}} \times 100$$

where R (%) is the cadmium removal efficiency, C₀ is the initial Cd²⁺ concentration, and Cₜ is the Cd²⁺ concentration at time t. See Afkhami, Abbas, Mohammad Saber-Tehrani, and Hasan Bagheri. Simultaneous removal of heavy-metal ions in wastewater samples using nano-alumina modified with 2, 4-dinitrophenylhydrazine. Journal of Hazardous Materials 181.1 (2010): 836-844, incorporated herein by reference in its entirety.

Effect of Synthesis Conditions on Membrane Properties.

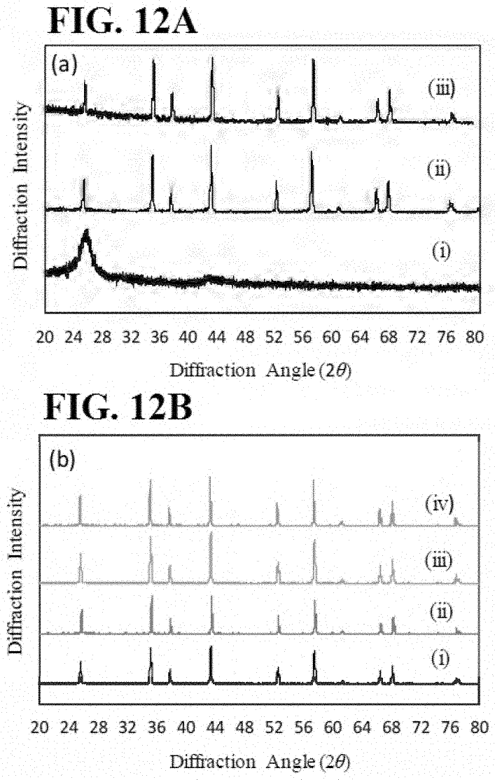

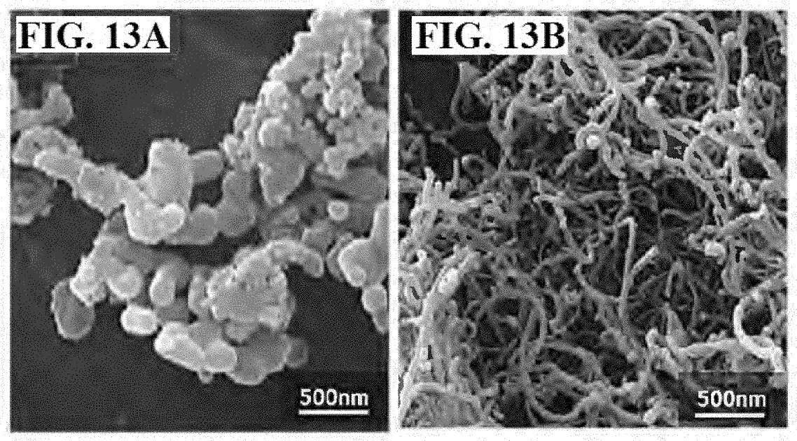

The XRD patterns of the raw alumina and CNT powders and of their mixture are presented in FIG. 12A. The diffraction peaks of the alumina and CNT samples match the corresponding reference patterns in the database available on the PDXL-2 analysis software (Rigaku Corporation). Only peaks corresponding to alumina emerged in the XRD patterns of the Al₂O₃/CNT mixture, whereas CNT peaks were absent that may be because of the small quantity of CNTs in the mixture (5 wt. %). No additional peaks were observed in the sintered samples (FIG. 12B), thus indicating that no new compound or phase had formed upon sintering. FIG. 12B shows the XRD patterns of the four membranes compacted under four different loads and sintered at 1,400° C. Similar XRD peaks were observed for all compacted samples. Moreover, the FE-SEM micrographs of the raw alumina and CNT powders are shown in FIGS. 13A and 13B where the large globular shapes are the alumina particles and the thin wiry shapes are the CNTs, respectively.

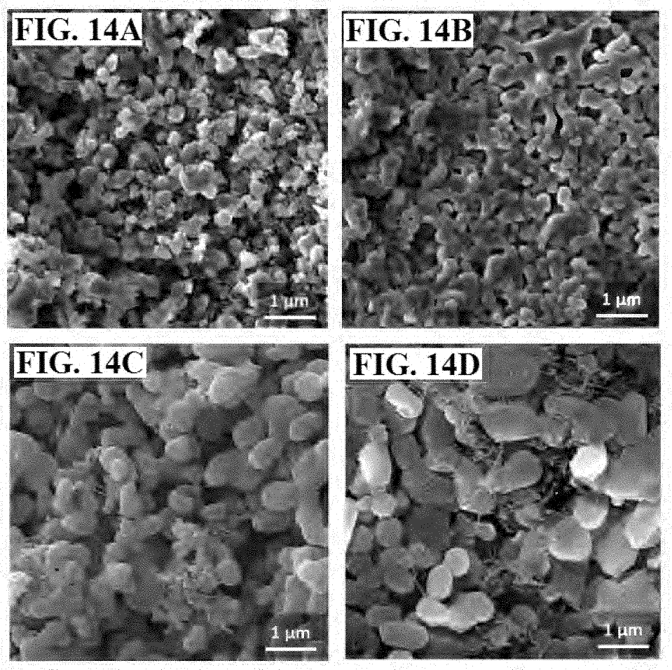

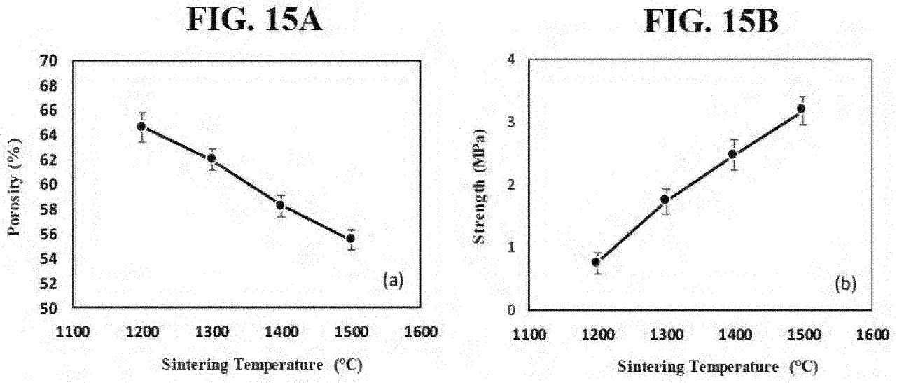

An experimental design matrix shown in Table 1b was used to evaluate the influence of the applied compaction load and sintering temperature on the properties of the Al₂O₃/CNT membrane. The effect of the sintering temperature on the membrane performance was then analyzed. Initially, the membrane samples C50T1200, C50T1300, C50T1400, and C50T1500 (Table-1b) were compacted under a low compaction load (50 kN) to limit the complete densification of the samples that may lead to pore shrinkage. These samples sintered at 1200, 1300, 1400, and 1500° C., respectively, and their SEM images are shown in FIGS. 14A-14D. Alumina particle growth was observed and the size of the alumina particles in the membrane increased with increasing sintering temperature. All samples in FIG. 14) exhibited significant porosity, confirming the successful fabrication of porous membranes. All the images of the membranes show that the CNTs were located along the grain boundaries, with small CNT bundles observed inside the larger pores. The average pore size of all the membranes shown in Table 1b, calculated from the SEM images using the ImageJ software, decreased from ˜1 to 0.5 μm with increasing particle size with sintering temperature.

Samples C50T1200 and C50T1300 showed lower compressional strength (0.76 and 1.74 MPa, respectively) because of their high porosity (65 and 62%, respectively) as shown in FIG. 7(a, b). Neither of these two samples could withstand pressures above 3 bar during the water flux test. On the other hand, samples C50T1400 and C50T1500 were stronger (showing higher strength of 2.4 and 3.2 MPa, respectively) than the first two samples (C50T1200 and C50T1300), FIG. 7(b). However, they also possessed large pores that rendered them unsuitable for high-flux applications FIG. 6 (c, d). These samples also cracked under a pressure of 5 bar in the permeation test. So, it implied that we must select higher compaction loads (more than 50 kN) and sintering temperatures to obtain optimum combinations of porosity and strengths.

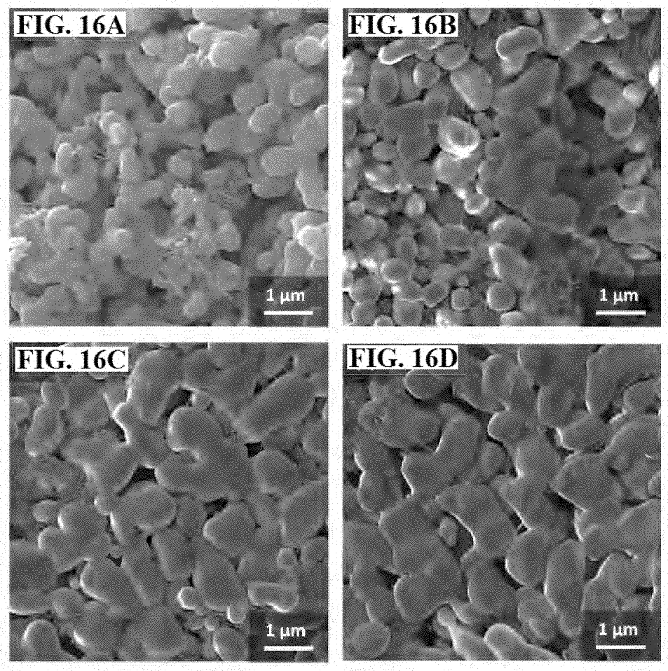

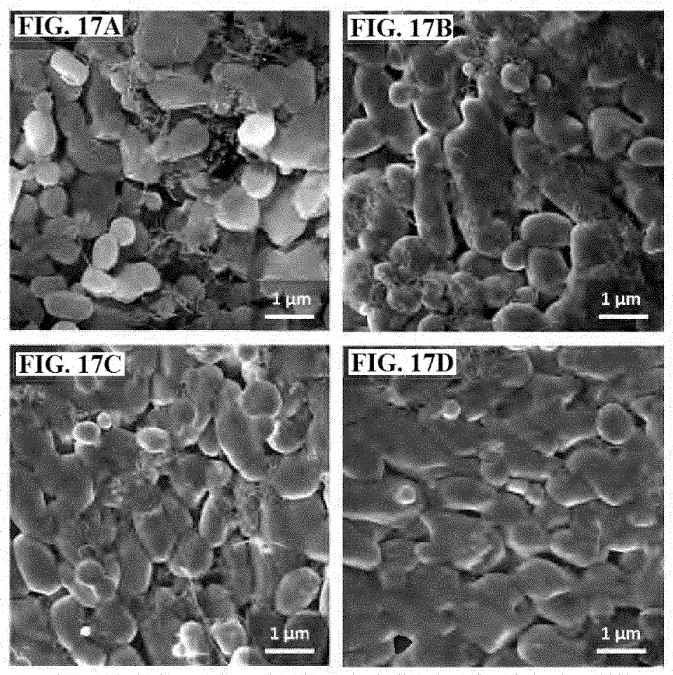

Further analysis focused on alumina/CNT composite membranes synthesized at the two higher sintering temperatures (1400 and 1500° C.) to obtain more strength in the sintered samples. In this case, the initial compaction load of membranes C100T1400, C150T1400, C200T1400 (sintered at 1400° C.) and C100T1500, C150T1500, and C200T1500 (sintered at 1500° C.) was increased from 50 to 100, 150, and 200 kN to obtain improved strength and render the membranes suitable for high water flux applications. The FE-SEM micrographs in FIGS. 16 and 17 reveal an increase in the alumina particle size with increasing compaction load, owing to enhanced grain growth during sintering. This enhanced growth was attributed to coalescence and neck growth processes in adjacent alumina particles. The higher initial compaction load led to shorter interparticle distances during the pressing process, resulting in the development of a strong network, as described elsewhere. See Korosh Shafieia et al.; and Sanjib Barma et al.; R. M. Spriggs, T. Vasilos, Effect of grain size on transverse bend strength of alumina and magnesia, J. Am. Ceram. Soc. 46 (5) (1963) 224-228.

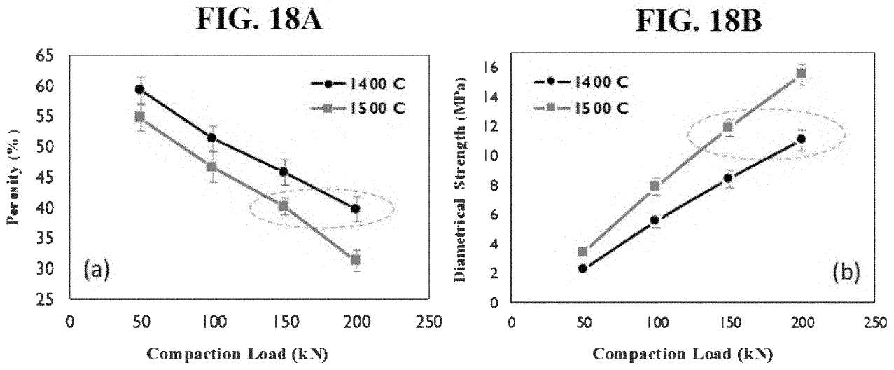

FIG. 18 shows the measured values of porosity and strength of these membrane samples. The porosity of all samples decreased which is because of the internal pore shrinkage that was attributed to the higher compaction load, as shown in FIG. 18A. On the contrary, an increasing trend in the membrane strength was observed with increasing compaction load, as shown in FIG. 18B. Interestingly, samples C200T1400 (Table 1b, prepared at 200 kN and 1400° C.) and C150T1500 (150 kN/1500° C.) showed statistically similar values of porosity (39.9 and 40.2%, respectively) and strength (11.0 and 11.9 MPa, respectively), as highlighted by the dashed circles in FIG. 18. Although, samples C100T1500 and C150T1400 also showed comparable values but their overall strength was lower than C200T1400 and C150T1500. The measured strengths of the present membranes are consistent with available data obtained via diametrical compression tests. See Faheemuddin Patel; and Ihsanullah et al.

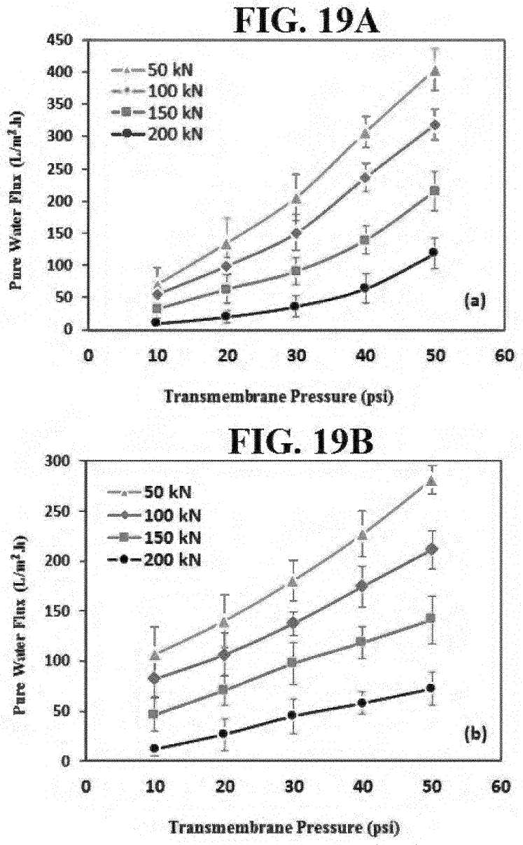

Water flux increased with transmembrane pressure (FIG. 19). The trend of water flux can be correlated to the porosity and strength of the samples. Samples with higher porosity or low strengths showed higher water flux. However, opposite behavior was investigated for less porous samples. Sample C200T1500 (synthesized at 200 kN/1500° C.) showed the lowest water flux among all samples, possibly as a result of the shrinkage and corresponding isolation of the pores within this membrane (Table 1b). See R. M. German, in: Sintering Theory and Practice, John Wiley & Sons, New York, 1996, incorporated herein by reference in its entirety. However, all membranes developed in the present study generally showed higher flux values than CNT-based composite membranes fabricated via CVD. See Tofighy, Maryam Ahmadzadeh, and Toraj Mohammadi. Nickel ions removal from water by two different morphologies of induced CNTs in mullite pore channels as adsorptive membrane. Ceramics International 41.4 (2015): 5464-5472, incorporated herein by reference in its entirety.

Removal of Cadmium from Aqueous Solution.

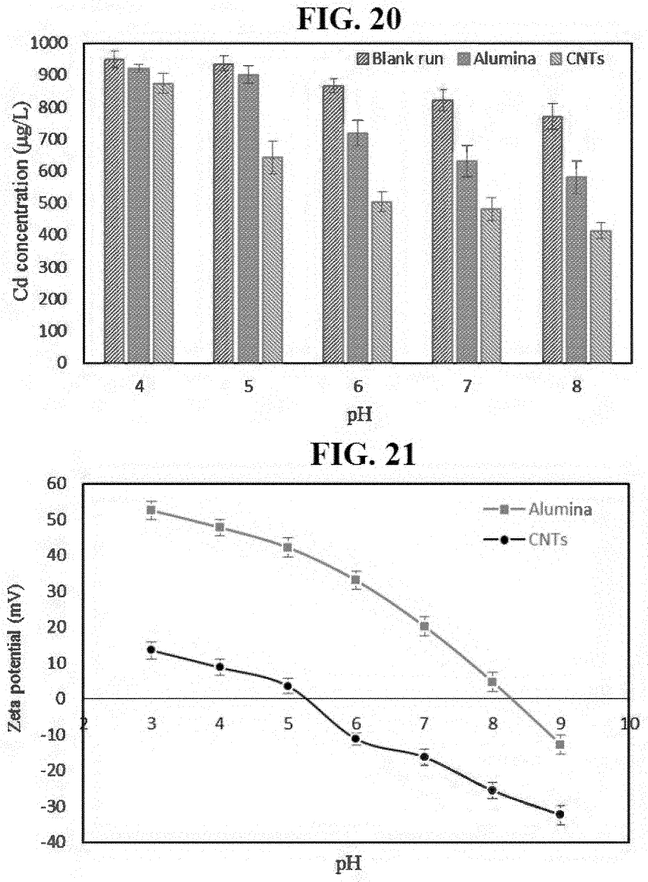

Because the adsorption of heavy metals by an adsorbent material depends on the pH of the solution, the inventors tested the Cd²⁺ removal performances of their materials on aqueous solutions of different pH; see Abbas et al. Cd²⁺ removal performance was initially evaluated for the individual alumina and CNT powders, using batch adsorption experiments on aqueous solutions of pH ranging between 3 and 8. As shown in FIG. 20, more cadmium removal was observed at pH >4 for the CNTs and pH >5 for alumina. Typically, cation adsorption is most effective at neutral or moderately basic pH levels. In this case, the best removal performance was observed at pH 8 for both materials; however, the corresponding changes in Cd²⁺ concentration observed in the blank runs suggest that Cd²⁺ precipitation may also affect the observed performance. See Adsorption of Cd(II) and Pb(H) from aqueous solutions on activated alumina, Tarun Kumar Naiya, Ashim Kumar Bhattacharya, Sudip Kumar Das, Journal of Colloid and Interface Science 333 (2009) 14-26, incorporated herein by reference in its entirety. Moreover, zeta potential analysis was performed to determine the surface charge of the alumina and CNT materials. The results shown in FIG. 21 highlight a point of zero charge (pHPZC) of 5.4 for the CNTs and 8.3 for alumina. Optimal adsorbent performance is known to occur at a pH slightly above the pHPZC. See Abbas et al.

Although maximal Cd²⁺ removal was observed at pH 8, the adsorbents also showed significant removal at pH 6. Because the typical pH of drinking water ranges from 6 to 8, the subsequent experiments to determine the Cd removal potential of the membranes in practical applications were performed at pH 6 and not the 8 (to avoid precipitation of Cd²⁺). Having identified the optimal pH of the solution, batch adsorption and column tests were performed to investigate the Cd removal capability of the alumina-CNT composite, both in the form of the powder mixture and of the synthesized membrane.

In the column tests, the alumina-CNT membrane sample C200T1400 (synthesized at 200 kN and 1400° C.) was placed in the flow loop system, and cadmium-contaminated water was run through the column only once. Table-2b compares the removal efficiency of the alumina-CNT powder mixture in the batch adsorption tests to that of the processed membrane (C200T1400) with the same composition in the column tests. Even though the powder mixture yielded a fairly good performance (53% removal), the membrane performed better (93%). This improved performance may be attributed to the synergistic effect of adsorption and separation by entrapment achieved with the membrane.

TABLE 2b
Cadmium removal efficiency of alumina, CNTs, alumina-CNT
(5 wt. %) powder mixture, and alumina/CNT membrane
with the same composition as the mixture.

| Adsorbents/Membrane | Removal Efficiency (%) |
|---|---|
| α-Alumina | 28 |
| CNT | 50 |
| Alumina-CNT powder mixture | 79 |
| Alumina-CNT membrane | 93 |

As shown by Example 2, the effects of initial compaction load and sintering temperature on the porosity, permeability, water flux, and strength of the resulting membrane were determined. The porosity and strength of the membrane were found to be influenced by both the compaction load and sintering temperature. However, interestingly, the sintering temperature was the primary factor influencing the pore size and water flux. An advantageous combination of processing parameters was identified by comparing the strength and porosity of membranes prepared under different conditions. Sample C200T1400 was selected for Cd²⁺ removal tests. The enhanced membrane removed 93% of the Cd²⁺ content from the contaminated water in a single passage. These data are consistent with use of this membrane for water treatment such as the removal of heavy metals such as cadmium.

Terminology.

Terminology used herein is for the purpose of describing particular embodiments only and is not intended to be limiting of the invention.

The headings (such as “Background” and “Summary”) and sub-headings used herein are intended only for general organization of topics within the present invention, and are not intended to limit the disclosure of the present invention or any aspect thereof. In particular, subject matter disclosed in the “Background” may include novel technology and may not constitute a recitation of prior art. Subject matter disclosed in the “Summary” is not an exhaustive or complete disclosure of the entire scope of the technology or any embodiments thereof. Classification or discussion of a material within a section of this specification as having a particular utility is made for convenience, and no inference should be drawn that the material must necessarily or solely function in accordance with its classification herein when it is used in any given composition.

As used herein, the singular forms “a”, “an” and “the” are intended to include the plural forms as well, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

As used herein, the term “and/or” includes any and all combinations of one or more of the associated listed items and may be abbreviated as “/”.

As used herein in the specification and claims, including as used in the examples and unless otherwise expressly specified, all numbers may be read as if prefaced by the word “substantially”, “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), +/−15% of the stated value (or range of values), +/−20% of the stated value (or range of values), etc. Any numerical range recited herein is intended to include all subranges subsumed therein.

Disclosure of values and ranges of values for specific parameters (such as temperatures, molecular weights, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10 it also describes subranges for Parameter X including 1-9, 1-8, 1-7, 2-9, 2-8, 2-7, 3-9, 3-8, 3-7, 2-8, 3-7, 4-6, or 7-10, 8-10 or 9-10 as mere examples. A range encompasses its endpoints as well as values inside of an endpoint, for example, the range 0-5 includes 0, >0, 1, 2, 3, 4, <5 and 5.

As used herein, the words “preferred” and “preferably” refer to embodiments of the technology that afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the technology. As referred to herein, all compositional percentages are by weight of the total composition, unless otherwise specified. As used herein, the word “include,” and its variants, is intended to be non-limiting, such that recitation of items in a list is not to the exclusion of other like items that may also be useful in the materials, compositions, devices, and methods of this technology. Similarly, the terms “can” and “may” and their variants are intended to be non-limiting, such that recitation that an embodiment can or may comprise certain elements or features does not exclude other embodiments of the present invention that do not contain those elements or features.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present invention.

Spatially relative terms, such as “under”, “below”, “lower”, “over”, “upper”, “in front of” or “behind” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

The description and specific examples, while indicating embodiments of the technology, are intended for purposes of illustration only and are not intended to limit the scope of the technology. Moreover, recitation of multiple embodiments having stated features is not intended to exclude other embodiments having additional features, or other embodiments incorporating different combinations of the stated features. Specific examples are provided for illustrative purposes of how to make and use the compositions and methods of this technology and, unless explicitly stated otherwise, are not intended to be a representation that given embodiments of this technology have, or have not, been made or tested.

All publications and patent applications mentioned in this specification are herein incorporated by reference in their entirety to the same extent as if each individual publication or patent application was specifically and individually indicated to be incorporated by reference, especially referenced is disclosure appearing in the same sentence, paragraph, page or section of the specification in which the incorporation by reference appears.

The citation of references herein does not constitute an admission that those references are prior art or have any relevance to the patentability of the technology disclosed herein. Any discussion of the content of references cited is intended merely to provide a general summary of assertions made by the authors of the references, and does not constitute an admission as to the accuracy of the content of such references.

1. A porous alumina-carbon nanotube membrane comprising at least about 90 wt. % Al₂O₃ and between about 0.5 wt. % and about 5 wt. % carbon nanotubes.

2. The porous alumina-carbon nanotube membrane of claim 1 that comprises a ceramic matrix comprising Al₂O₃.

3. The porous alumina-carbon nanotube membrane of claim 1 that does not contain one or more of zircon, tin, phosphorous, magnesium, yttrium, barium, and/or tantalum.

4. The porous alumina-carbon nanotube membrane of claim 1 that consists of sintered Al₂O₃ and carbon nanotubes.

5. The porous alumina-carbon nanotube membrane of claim 1 that is further functionalized by at least one ligand that binds to a metal.

6. The porous alumina-carbon nanotube membrane of claim 1 that is produced by conventional sintering.

7. The porous alumina-carbon nanotube membrane of claim 1 that is produced by uniaxially pressing the mixture and by pressureless sintering.

8. The porous alumina-carbon nanotube membrane of claim 1 that is produced by sintering in a tube furnace and not by spark plasma sintering.

9. The porous alumina-carbon nanotube membrane of claim 1 that is produced by spark plasma sintering (“SPS”).

10. The porous alumina-carbon nanotube membrane of claim 1 that is produced by spark plasma sintering performed at a pressure of 5.6 to 20 MPa, a temperature of 1,000 to 1,200° C., a heating rate of 180 to 200° C./min, and a holding time of 2.5 to 10 mins.

11. The porous alumina-carbon nanotube membrane of claim 1 that is formed by sintering a mixture of the Al₂O₃ and carbon nanotubes and at least one pore former in an amount ranging from 0.1 to 10 wt. % and dispersant in an amount ranging from 0.1 to 10 wt. % of the mixture that is sintered.

12. The porous alumina-carbon nanotube membrane of claim 1 that is formed by sintering a mixture of the Al₂O₃ and carbon nanotubes and at least one pore former that is starch and dispersants that are gum Arabic and sodium dodecyl sulfate.

13. A filter comprising the porous alumina-carbon nanotube membrane of claim 1.

14. The porous alumina-carbon nanotube membrane of claim 1 that is produced by hot pressing, by hot isostatic pressing, or by otherwise applying pressure and heat/temperature simultaneously to the mixture.

15. A method for making a porous alumina-carbon nanotube membrane comprising sintering a mixture comprising at least 90 wt. % Al₂O₃ and between about 0.5 wt. % and about 5 wt. % carbon nanotubes.

16. The method of claim 15, wherein the mixture comprises at least 90 wt. % Al₂O₃ and between about 0.5 wt. % and about 5 wt. % carbon nanotubes and does not contain one or more of zircon, tin, phosphorous, magnesium, yttrium, barium, and/or tantalum.

17. The method of claim 15, wherein the mixture consists of at least 90 wt. % Al₂O₃ and between about 0.5 wt. % and about 5 wt. % carbon nanotubes.

18. The method of claim 15, wherein the sintering comprises spark plasma sintering.

19. The method of claim 15, wherein the sintering consists of spark plasma sintering (SPS) performed at:
a pressure of 5.6 to 20 MPa,
a temperature of 1,000 to 1,200° C.,
a heating rate of 50 to 200° C./min, and
a holding time of 2.5 to 10 mins.

20. The method of claim 15, wherein the mixture is uniaxially pressed and then pressurelessly sintered.

21. A method for removing a heavy or toxic metal from water comprising contacting an aqueous solution containing cadmium, which has a pH ranging from 5.5 to 8.5, by contacting the aqueous solution with a porous alumina-carbon nanotube membrane that comprises at least about 90 wt. % Al₂O₃ and between about 0.5 wt. % and about 5 wt. % carbon nanotubes, and recovering water from which the heavy or toxic metal has been removed.

22. The method of claim 21, wherein the heavy metal is cadmium.
